(19) United States
(12) Patent Application Publication
(10) Pub. No.: US 2016/0225372 A1
(43) Pub. Date: Aug. 4, 2016

(54) SMART HOME CONNECTED DEVICE CONTEXTUAL LEARNING USING AUDIO COMMANDS

(71) Applicant: Samsung Electronics Company, Ltd., Suwon-si (KR)

(72) Inventors: Eric Cheung, Irvine, CA (US); Vita Markman, Los Angeles, CA (US); Fabio Gava, Ladera Ranch, CA (US)

(21) Appl. No.: 14/672,667

(22) Filed: Mar. 30, 2015

Related U.S. Application Data
(60) Provisional application No. 62/111,546, filed on Feb. 3, 2015.

(51) Int. Cl. G10L 15/22; G10L 15/06; G10L 15/197

(52) U.S. Cl. CPC G10L 15/22; G10L 15/197; G10L 15/063; G10L 2015/223; G10L 2015/088

(57) ABSTRACT

A method includes receiving an audio command by an electronic device to perform an action. Context related to the audio command is learned by one or more other electronic devices connected with the electronic device. One or more other actions are performed by the one or more other electronic devices based on learned context from the audio command received by the electronic device.

### CROSS-REFERENCE TO RELATED APPLICATIONS

This application claims the priority benefit of U.S. Provisional Patent Application Ser. No. 62/111,546, filed Feb. 3, 2015, which is incorporated herein by reference in its entirety.

### TECHNICAL FIELD

One or more embodiments relate generally to smart home connected devices, in particular, to learned context for one or more connected smart devices using an audio command to a particular connected smart device.

### BACKGROUND

Smart devices are used by consumers to perform actions using a home network. Conventional systems may use the Internet using a cell phone to turn on a light, change a setting on a thermostat or open/close a garage door. These actions for connected devices are made by a selection on a graphical user interface (GUI) on a cell phone or tablet that is part of an app. Conventionally, all of these actions are manually selected (e.g., using a touch screen) by a user of the controlling device (e.g., cell phone or tablet).

### SUMMARY

In one embodiment, a method includes receiving an audio command by an electronic device to perform an action. Context related to the audio command is learned by one or more other electronic devices connected with the electronic device. One or more other actions are performed by the one or more other electronic devices based on learned context from the audio command received by the electronic device.

One embodiment provides an apparatus that includes an electronic product device connected with one or more other electronic product devices. The electronic product device is configured to receive an audio command, to interpret the audio command, to perform an action, and to communicate with the one or more other electronic product devices for learning context related to the audio command by the one or more other electronic product devices. The one or more other electronic product devices are configured to perform one or more other actions based on learned context from the audio command received by the electronic product device.

Another embodiment provides an apparatus. The apparatus comprising: an electronic device coupled with a processor. The electronic device: provides interactive agent virtualization for potentially solving one or more of common problems and new problems for one or more products using information that is collected from a plurality of agent interactions with a plurality of clients.

These and other aspects and advantages of the embodiments will become apparent from the following detailed description, which, when taken in conjunction with the drawings, illustrate by way of example the principles of the embodiments.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows an example product device and example electronic devices having one or more sensor devices that are implemented, according to an embodiment.

FIG. 2 shows an example of communication from example electronic devices that have one or more sensor devices and a server or cloud-based service, according to an embodiment.

FIG. 3 shows an example flow diagram for interactive agent virtualization for product problem identification and potential problem solving, according to an embodiment.

FIG. 4 shows an example interactive agent session, according to an embodiment.

FIG. 5 shows an example dialog for narrowing a hypothesis for an example interactive agent session, according to an embodiment.

FIG. 6 shows an example determination of sensibility of sensors for one or more electronic devices, according to an embodiment.

FIG. 7 shows an example dialog for instructing a user for an example interactive agent session, according to an embodiment.

FIG. 8 shows an example dialog for determining a solution and providing information for correction of a problem for an example interactive agent session, according to an embodiment.

FIG. 9 shows an example for integration of using chat log information into the interactive agent virtualization flow of FIG. 3, according to an embodiment.

FIG. 10 shows a block diagram of extraction of core problems from customer/client collected information, according to an embodiment.

FIG. 11 shows a block diagram of discovery of new topics in customer/client collected information, according to an embodiment.

FIG. 12 a block diagram of discovery correlations between product model numbers and dominant problems, according to an embodiment.

FIG. 13 shows a flow diagram for expanding the topic-indicative phraselets using language modeling and synonyms, according to an embodiment.

FIG. 14 another flow diagram for expanding the topic-indicative phraselets using language modeling and synonyms, according to an embodiment.

FIG. 15 shows a flow diagram for interactive agent virtualization for product problem solving, according to an embodiment.

FIG. 16 shows a flow diagram for expanding the topic-indicative phraselets for a Smart Home system using language modeling and synonyms, according to an embodiment.

FIG. 17 shows an example interaction by smart home devices in a network that use language modeling and synonyms, according to an embodiment.

FIG. 18 shows a flow diagram for a Smart Home contextual product interaction, according to an embodiment.

FIG. 19 is a high level block diagram showing a computing system useful for implementing an embodiment.

FIG. 20 is a block diagram showing an example electronic device useful or implementing an embodiment.

### DETAILED DESCRIPTION

The following description is made for the purpose of illustrating the general principles of the embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to a network of devices (e.g., consumer product smart devices) that learn context using an audio command (e.g., a spoken utterance). One example includes a unified Smart Home natural language-based interface/control platform. In one example, a user interface/user experience (UI/UX) is provided that links individual device-specific commands to unify control of multiple devices by learning user contexts. Smart home networked devices and functionalities for controlling devices and appliances via a cloud-based platform may be used for smart device actions based on learned context.

Another embodiment relates to automated support using unconnected devices that are informed from targeted cluster discovery of mined data. One example method identifies clusters of common problems for one or more products from information collected from a plurality of agent interactions with multiple clients. Common problems are correlated with the one or more products. New problems for the one or more products are discovered based on mining of the agent interactions. Interactive agent virtualization is provided for potentially solving one or more of the common problems and new problems for the one or more products.

One example provides automated support with minimal cost (e.g., both manpower and manufacturing) by using generic smart devices (e.g., smart phones, tablets, wearable devices, television (TV) devices, etc.) with sensors (e.g., vibration sensor information, temperature sensor information, sound information, humidity information, magnetic field information, proximity information, light information, rotational information, movement information, etc.) and unconnected products (e.g., devices, appliances, technology connections, etc.). In one example, the smart device is further “informed” by data gathered from customer support information, such as chat logs, from which common product problems that are experienced by customers are mined. The mined data is used to guide a virtual intelligent agent to make better hypothesis and propose solutions for solving problems with products.

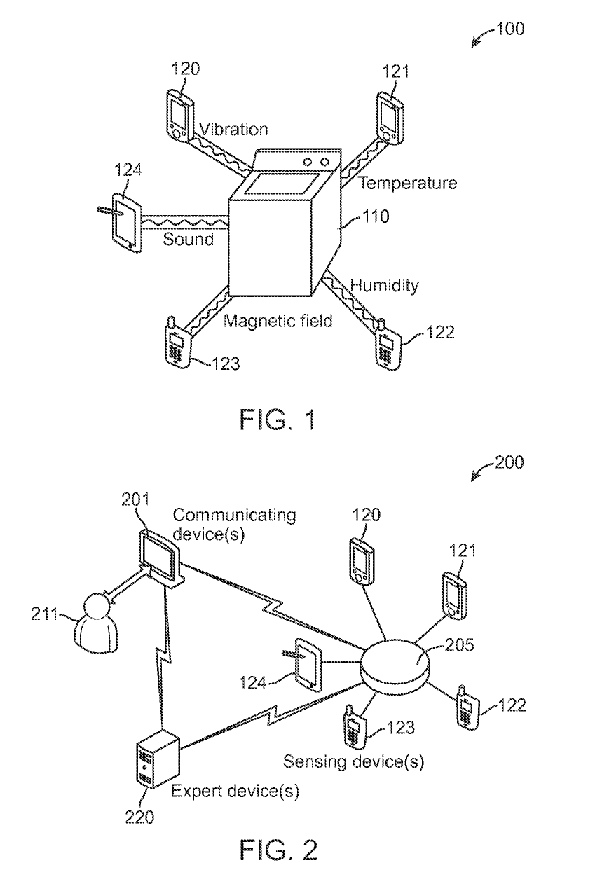

FIG. 1 shows an example product device 110 and example electronic devices 120, 121, 122, 123 and 124 having one or more sensor devices that are implemented, according to an embodiment. For illustration purposes, the example product device 110 shown is a washing machine device, but may be any other smart home device, connectable/communicable smart device, or collection of smart devices, e.g., an alarm clock, a coffee maker, a television, a refrigerator, a thermostat, a heating/cooling system, an oven, a microwave oven, lighting devices, outlets, shower controls, motorized curtain/blinds, water controls (e.g., sprinkler system, watering system, etc.), other smart appliances, smart controllers, etc. In one example, a product device 110 may include any electronic device that may connect with other electronic devices or network(s) wirelessly (or wired) using a wireless protocol (e.g., BLUETOOTH®, NFC, Wi-Fi, 3G, 4G, etc.) and that is capable to operate interactively and autonomously, may include computing capabilities, listening/speech recognition capabilities, user interaction capabilities, sound producing capabilities, indicators (e.g., light, sound, voice, etc.), etc. Additionally, product devices 110 may include any other smart device properties, functionalities, sensors, network communication capabilities, wireless interaction with other product devices 110, learning capabilities, tracking capabilities (e.g., interaction history, use history, product device 110 communication history, etc.), updating capabilities, processing and memory expansion capabilities, etc.

In one example, the electronic devices 120-124 each include different sensors that may be used for assisting in solving a problem with the example product device 110. The electronic devices 120-124 may each have several sensor devices that are the same or different for each electronic device 120-124. It should be noted that while five (5) electronic devices 120-124 are shown for example, more or less (e.g., 1, 2, 3, 4, 6, 10, etc.) electronic devices with sensors may be used depending on availability and particular sensor types included in each electronic device.

The sensors on the electronic devices 120-124 (e.g., sensing devices) collect signals that the sensors detect. Each sensor may detect a unique aspect of a test event (e.g., turning on the example product device 110, entering a particular mode, etc.) because of its unique sensing capability and because of its placement during the test event. Essentially, in one example the sensors of the electronic devices 120-124 are the “eyes and ears” of a virtual technician used by a virtual agent application. In one example, the electronic device 120 is a smart phone device and collects signals from vibration and temperature sensors. Alternatively, electronic device 121 may be used for collecting temperature signals using a temperature sensor. In one example, the electronic device 120 is placed on top of the example product device 110, and detects the motion, for example, from a rotating motor, and temperature change. The electronic device 123 is may also be placed on the top of the example product device 110, and collects the magnetic field changes from the rotating motor and the humidity change from different wash cycle. Alternatively, electronic device 122 may be used for collecting humidity signals using a humidity sensor. The electronic device 124 may be used to listen to the sound made by the example product device 110 using a microphone. The electronic device 124 may be placed on the floor to minimize the noise generated by the vibration of the electronic device 124 itself.

After the test using the one or more electronic devices 120-124 and the one or more different sensors, a communicating device (e.g., one of the electronic devices 120-124, a separate computing device connected to a network (e.g., the Internet), a smart TV device, a server or cloud-based service, etc.) verifies the data collection is complete. In one example, the data collection may be incomplete if some of the sensors fail to gather the proper data, or the data analysis requested requires more than one set of data. In this case, for example, the data collection steps may repeat. In one embodiment, the placement and collection of data is used for Technician emulation, which simulates the actions that a technician may perform in a customer's home. The technician may typically make observations by using senses (sight, hearing, taste, smell, touch). Although the sensors on the devices mostly only emulate a portion of human senses (e.g., sight by capturing on a camera, hearing by listening from a microphone, and touching by using a motion sensor), the sensors of the electronic devices 120-124 provide much greater accuracy and other measurements (e.g., magnetic field, temperature, humidity, etc.) that otherwise would need special equipment for measurements.

FIG. 2 shows an example 200 of communication from example electronic devices 120-124 that have one or more sensor devices and a server or cloud-based service, according to an embodiment. In one embodiment, a communication device 205 (e.g., wired/wireless router, cellular system, cable, satellite, etc.) and/or a user 211 device 201 (e.g., computing device) provides for communication of data/information to an expert device 220 (e.g., a server, cloud-based service, smart phone, tablet, etc.). In one example, the signals collected by the sensing devices are aggregated into a collection of signal information. The information is sent to the expert device 220 that performs an analysis. The signal information may either be sent real-time during the testing, or sent as a package after the test. In one example, the expert device 220 is provided as a service through the Internet. The web service analyzes the signals from the sensors to detect anomaly, and assists in eliminating or verifying hypotheses regarding product problems.

In one example, the result of the data analysis feeds back to the hypothesis evaluation. With more information about a product or technology problem, the evaluation portion updates its evaluation and proposes the proper next step. Eventually with enough information, the most likely problem may be identified.

The above-described processing is referred to as expert analysis, where the data collected from various sensors from the sensing devices is analyzed to verify or eliminate items from the list of hypotheses. In one embodiment, the expertise of a well-trained technician is replaced by artificial intelligence (AI). These AI processes are trained with different kind of data with different device/appliance issues.

One or more embodiments include: caller-agent virtualization, technician emulation and expert analysis, which may not involve sequential steps, but includes interacting units. One or more embodiments provide for text mining customer support chat information in order to arrive at the common problems customers experience, and thus provide additional data sources for technician emulation and expert analysis. Mining of customer support chat information for common problems enable processes to populate a data base (or other storage device or organized storage element) with known problems and their respective descriptions. The use of mining customer or client information enables one or more embodiments to have a collection of text characterizing the way customers tend to describe their problems, which may be different from the “official” technical description of a given problem. These descriptions may then be used to match new problems reported via the intelligent device systems of one or more embodiments to the problems already reported by many customers in customer support chat logs or other collections of customer information. In one example, a user's description of a mal-functioning TV, such as “I see dots on my TV” may be matched to the existing problems collected from customer support chat logs that contain complaints (e.g., “TV has white dots”). Text mining of customer support chat further facilitate discovery of novel problems that arise and may be used as crucial information source for troubleshooting issues with electronic devices (e.g., electronic devices 120-124) during technician emulation and expert analysis.

Caller-agent virtualization simulates the experience of a customer's iterative interactions with the customer support agent. The agent does not just simply search and retrieve information on the problem at issue. In one example, a virtual agent interactively communicates with the customer in a conversation (e.g., voice, text, etc.). From the conversation, the virtual support agent obtains insight on customer's problems with products or technology and creates a list of hypotheses on the problems that the customer has. The virtual agent iteratively narrows down the list of hypotheses with artificial intelligence by providing questions that the customer can either answer or not. The virtual agent also considers other environment data and history (e.g., product history information, service information, customer information, etc.). One key source of support data is obtained from customer support chat logs that contain information about common problems reported by various customers. In some cases, the virtual agent may even resolve customer's problem with only conversation. In one or more embodiments, the virtual support agent provides the same experience as a real-world support agent on a communicating device (e.g., a TV, smart phone, tablet, wearable device, etc.). In one example, the virtual agent and customer conversation may be conducted through voice, a user interface, a combination of both, etc.

In one embodiment, technician emulation is provided to simulate the actions that a technician would perform in a customer's home. The technician would typically perform various actions on the device or appliance, and make observations to narrow down the problems from a list of hypotheses. For virtual support, sensing devices are devices that have sensors to act as the “eyes and ears” of the virtual technician. Examples of such sensing devices may include televisions, smart phones, tablets, and sometimes appliances. In one example, the communicating device instructs the customer to perform simple actions, such that the sensing devices are placed in particular locations in proximity with a product that the customer is having a problem with. For example, in problems with a washing machine, the communicating device (e.g., a TV) instructs the customer to place a smart phone on one corner of the washing machine and start a wash cycle with an empty load. Signals that are detected from all sensing devices are aligned and aggregated. Note that the device or appliance that is being examined does not have to connect to a network nor communicate with the sensing device (as most appliances are not network capable), and some device problems might prevent the devices from connecting to a network.

In one embodiment, expert analysis processing includes collecting data from various sensors from the sensing devices that is analyzed to verify or eliminate items from a list of hypotheses. In one embodiment, the expert analysis processing is provided by the expert device 220. In one example, the analysis involves various kinds of AI technology, such as an expert system, machine learning, decision trees, or custom rules. For example, the vibration signal coming from a movement sensor on a smart phone when a dryer motor is running, the audio signal coming from the mechanical motor received on the smart phone and the TV, and the operation information on the dryer, are aligned and aggregated and sent to a service on the Internet, where machine learning processing is used to find the anomaly on the signals versus the normal signals on a database. In one embodiment, other machine learning processes may be used to classify the problem from those signals. When connected to the network (such as running on server, or a peer-to-peer network), the expert device 220 may also utilize other data collected for analysis. One source of such external data arises from conducting text mining of customer support chat logs to extract common problems that customers experience. This also facilitate new problem discovery, as new problems are also reported in online chat between agents and customer support. For newly discovered common anomaly (probably based on aging of the appliance, or changes in the operating environment), the problem database may be updated to include the new problem and the problem may be reported to the device or appliance manufacturer.

The results from expert analysis is part of the input for caller-agent virtualization for narrowing down the list of hypotheses. The caller-agent virtualization might request additional analysis on the existing data collected from the technician emulation. Multiple technician emulation actions might be requested so that the expert analysis is provided enough data to conduct analysis with. If the problem cannot be fixed by the customer themselves and an actual technician and/or replacement parts are needed, the virtual support agent communicates with the customer to purchase parts and/or schedule an appointment with an actual technician.

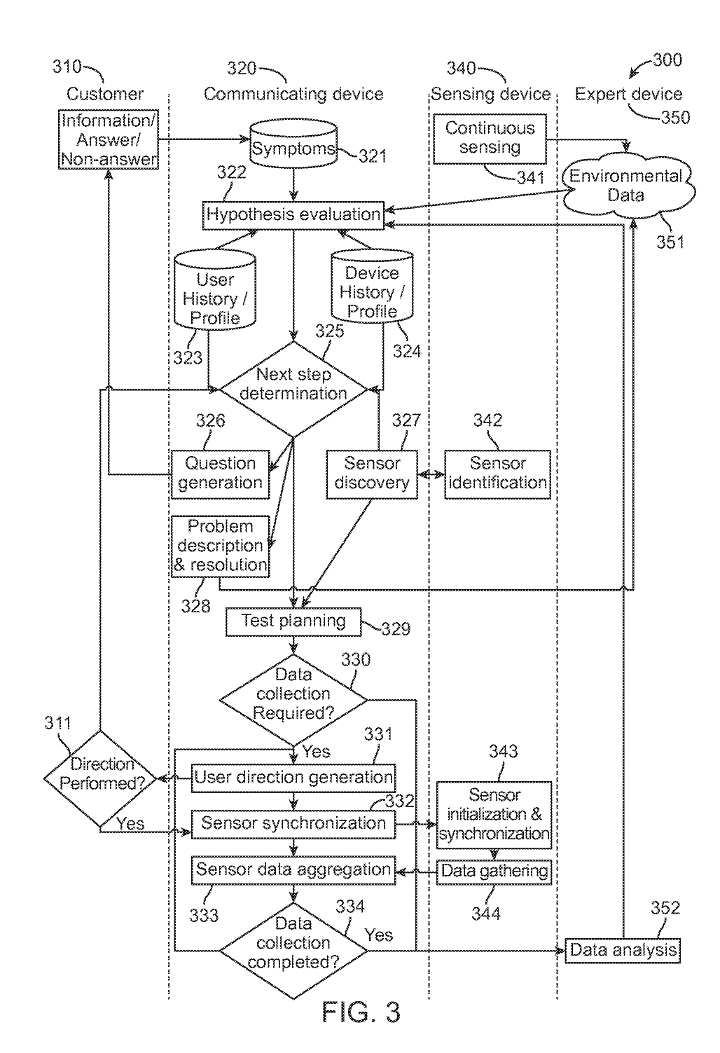

FIG. 3 shows an example flow diagram 300 for interactive agent virtualization for product problem identification and potential problem solving, according to an embodiment. In one embodiment, the interactive agent virtualization includes multiple interactions that include the customer interaction 310 (e.g., providing information, answering questions, non-answers, etc.), communicating device interaction 320, sensing device interaction 340 and expert device interaction 350. In one example, the communicating device interaction 320 includes accessing a symptoms database 321, hypothesis evaluation 322, accessing a user history/profile database 323, a device history/profile database 324, next step determination 325, question generation 326, sensor discovery 327, problem description and resolution 328, test planning 329, data collection requirement processing 329, user direction generation 331, sensor synchronization 332, sensor data aggregation 333, and data collection completed determination 334.

In one embodiment, the sensing device interaction 340 includes continuous sensing 341, sensor identification 342, sensor initialization 343 and data gathering 344. In one example the expert device interaction 350 includes environmental data analysis 351 and data analysis 352. The customer interaction 310 may also include performing instructed directions 311.

Virtual support is a software running on a set of electronic devices (i.e. televisions, smart phones, etc.) to emulate the experience of customer support typically conducted by a human support agent and technicians. Instead of communicating with real people, the customer would be interacting with the electronic devices.

In the following description, a problem on a washing machine is used to illustrate the flow and the technology of the virtual support embodiments. In the example using the washing machine as an exemplary product that a customer is having a problem with, the customer also has a TV, two smart phones with a microphone, motion sensor, magnetic field sensor, temperature sensor, and humidity sensor, and a tablet with a microphone and motion sensor. In one embodiment, the virtual support processing may be included in electronic devices or provided in an application (e.g., a third party application, a manufacturer application, etc.).

In one example, a new support session is initiated from, for example, the customer knows there is a problem on one of his/her devices or appliances and initiates a new virtual support session. During a verbal initiation stage the customer gives description of the problem to the virtual support agent during customer interaction 310. The description may then be matched to one of many common problems extracted from customer support chat information. In another example, the session may be activated based on the expert device being aware that one of the devices or appliances might have a problem before the customer knows, and notifies the customer in a new virtual support session.

In one example, at first when the customer sees something wrong in their washing machine, they may initiate a new virtual support session by, for example, talking to the TV. In this example, the TV is acting as the communicating device. Alternatively the customer may talk to his smart phone or tablet. The TV would then engage the customer into a dialog to gather the problem symptoms observed by the customer. The symptoms are used to evaluate potential problems (hypotheses). Possible candidates for potential problems may also be extracted from a database of common problems collected from customer support chat and the best matching candidate may be selected.

During the hypothesis evaluation, the virtual support system considers more than just the symptoms provided by the customer. To accurately determine the problem, the evaluation considers the following in additional to the symptoms:
1. User history and profile 323: Different people describe the same symptom differently. Hence, to accurately determine the meaning of the symptoms being reported, the evaluation step considers how the user reported previous events. The evaluation step may also take into account how other users reported similar event(s), relying on the data collected from customer support chat information. The context information may be stored in a database or other memory organization technology.
2. Device history and profile 324: Device profiles help the evaluation to determine the ideal behavior of the device or appliance, and device history may help determining the component/part that may be failing. This context information may be stored in a database or other memory organization technology.
3. Environmental data 351: There are two types of environmental data: internal and external. Internal data are those that are collected in a customer's environment, such as temperature, which may affect the probability where certain problem occurs. External data are those outside a customer's environment such that a common problem discovered on the same device/appliance on other customer's device/appliance would be more likely to happen in this customer's device/appliance. This external data may be found on a system running the virtual support processing technology in other households; or on the information extracted from the customer support chat.

In one example, further hypothesis evaluation after tests would also include those analysis results. At the end of this processing, the TV would have a list of hypotheses for the problems the customer has.

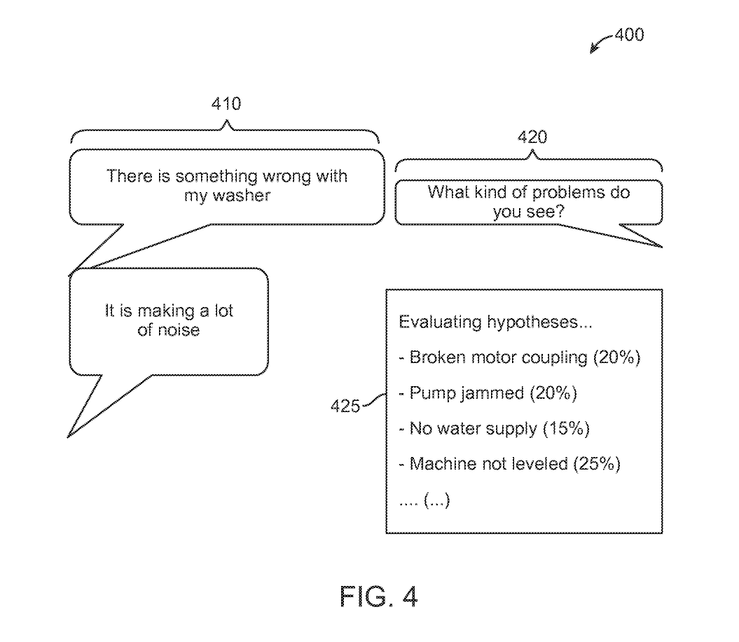

FIG. 4 shows an example interactive agent session 400, according to an embodiment. The sample dialog includes customer dialog 410 and virtual agent dialog 420. The initial processing 425 on the TV (or other communicating device) is also illustrated. With the hypothesis evaluated, the communicating device determines the best next step. In one example, there are three possibilities:
1) The problem is confidently identified. This is possible when the problem can be identified by only knowing the symptoms without any technician emulation or export analysis. With the problem identified, resolution and possible fixes may be proposed to the user, without any support personnel's involvements. At the same time, the result may be sent to the network that is shared between customers (e.g., server or peer-to-peer network) and the result may help other customers for analysis and the manufacturers for analytics.
2) Ask the customer more questions. This processing occurs when the next step determination determines that it is easier to ask a question than ask the customer to help perform a test. Several factors are involved in this decision. In one example, it may be that based on customer's user history/profile, they are capable to answer some detailed questions or they are less able to help perform a test. In this case, a question is generated to ask the customer (e.g., via on-screen text/graphics, video, synthesized voice, etc.) and wait for customer's response. Both answer and non-answer (when the customer is not able to answer the question or takes too long to reply) feeds back into the hypothesis evaluation processing for further evaluation.
3) Ask the customer to help performing an action. This processing occurs when the next step determination determines that it is easier to ask the user to help perform an action (e.g., no further questions would help), the customer is less capable to answer questions, or the customer is efficient and the necessary sensing devices are available to perform the test. In this case, the caller-agent virtualization component passes the test to the technician emulation component to perform the test.

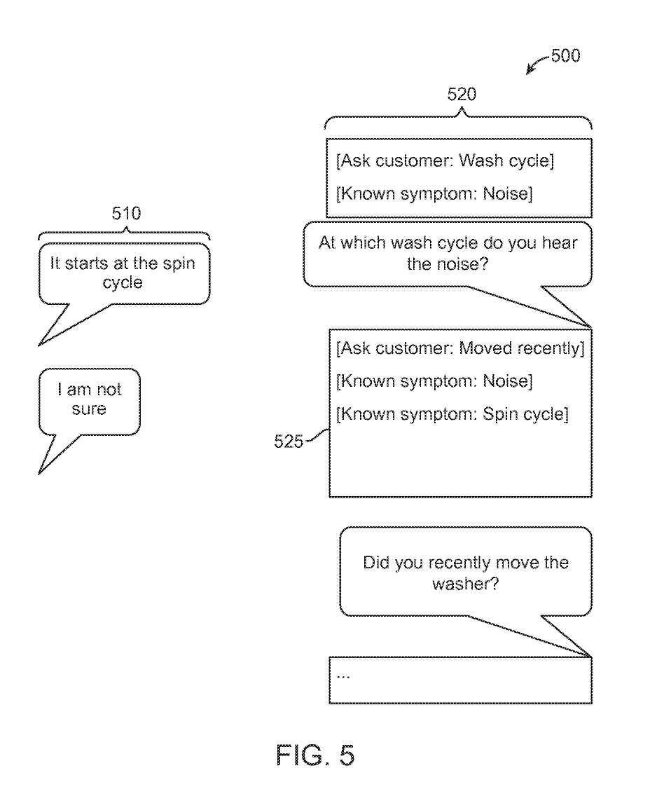

FIG. 5 shows an example dialog 500 for narrowing a hypothesis for an example interactive agent session, according to an embodiment. The sample dialog includes customer dialog 510 and virtual agent dialog 520. The processing 525 on the TV (or other communicating device) is also illustrated. In one example, if the next step determination determines to ask the customer more questions, the communicating device (TV in this example) continues engaging the customer in a conversation to gather more information (i.e. symptoms) to narrow down the hypotheses through implicit languages, dialogs, UI menus, or other means. The communicating device generates the question to the customer based on what is requested to be asked by the next step determination. The question is going to be more useful for efficiently narrowing down the problems while it is within the customer's capability to answer (based on the customer's history/profile). One important note here is that both answers and non-answers are important to narrow down the hypothesis.

The above processing composes caller-agent virtualization, which simulates the experience of a customer calling a customer support agent or initiating a chat online. From the conversation, the virtual support agent automatically gains insight on customer's problems and evaluates the hypotheses on the problems the customer has. Additionally, the virtual support agent relies on existing customer support chat logs that contain conversations between human agents and customers to extract key features for modeling dialogue between agent and customer. These features include, but are not limited to, use of common courtesy expressions by the agent, identifying the precise portion of the customer's language that contains the statement of the problem, asking follow up questions, etc. Data mined from customer support chat information is leveraged to build a model of agent-customer dialogue and make the dialog between the virtual agent and customer maximally adhering to linguistic cannons used by human agents.

In one example, when the caller-agent virtualization component determines that it is better to perform a test, the sensing devices are involved to gather enough data for the analysis. Before this happens, the communicating device discovers the set of sensing devices through a discovery mechanism. One example mechanism is Universal Plug and Play (UPnP) protocol, which allows networked devices to discovery each other's presence and capabilities. The discovery step provides the next step determination component information to determine that certain tests are possible with the set of available devices. Other discovery mechanisms may also include radio frequency identification (RFID), BLUETOOTH®, etc.

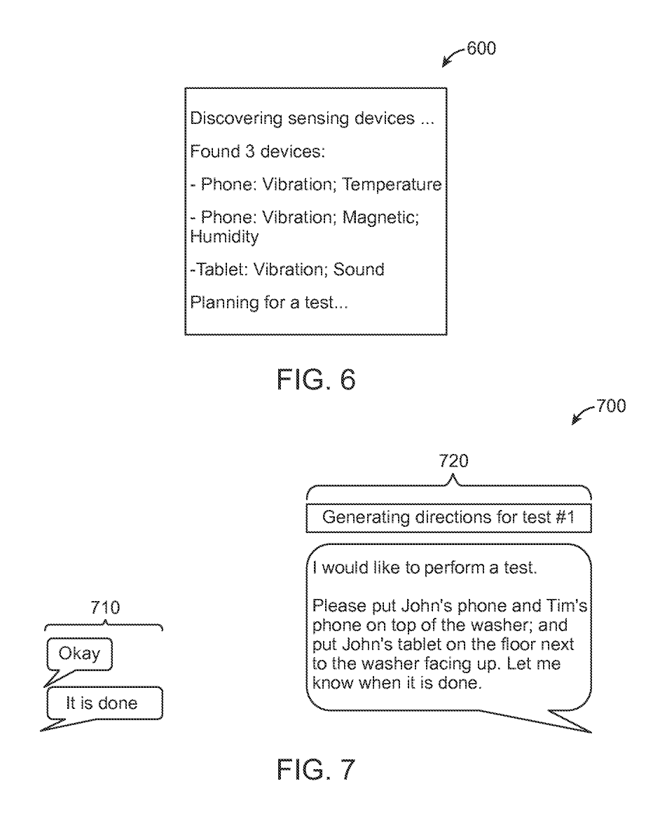

FIG. 6 shows an example 600 determination of sensibility of sensors for one or more electronic devices, according to an embodiment. The test planning process generates a test plan based on the sensing devices discovered. These sensing devices may be generic smart devices (such as smart phones) that allow third party applications to access their sensor data. Hence, the sensing devices do not need to be designed for diagnosing. In one example, the test plan needs to consider the capability of different sensibility from different sensing devices. Some devices have more sensors of various types than others, and some sensors provide better resolutions than others. In order to determine the sensibility of the sensors on the sensing devices, calibration processing is performed.

FIG. 7 shows an example dialog 700 for instructing a user for an example interactive agent session, according to an embodiment. In one example, the dialog 700 includes user dialog 710 and virtual agent dialog 720, which includes processing by the communicating device for generating test instructions for a user to follow. With a test planned, the communicating device generates directions for the customer to follow. In this illustration, the TV asks the customer to place their smart phones on top of the washing machine and place their tablet on the floor next to the washing machine facing up. The directions may come in the form of dialogs, graphics, synthesized voice, etc.

In some cases, the customer might not understand the directions or might not be capable of following the steps. In that case, the next step determination component finds an alternate next step to perform. Once the sensing devices are verified to be in place, the communicating device initializes and synchronizes the sensors on the devices and start collecting data. Since the device or appliance to be tested is not designed to be tested in this diagnosis, and it might not be connected and can't communicate with the communicating device, some customer action might be required if certain actions cannot be initiated automatically (e.g., turning on the washing machine or removing clothes from the washing machine).

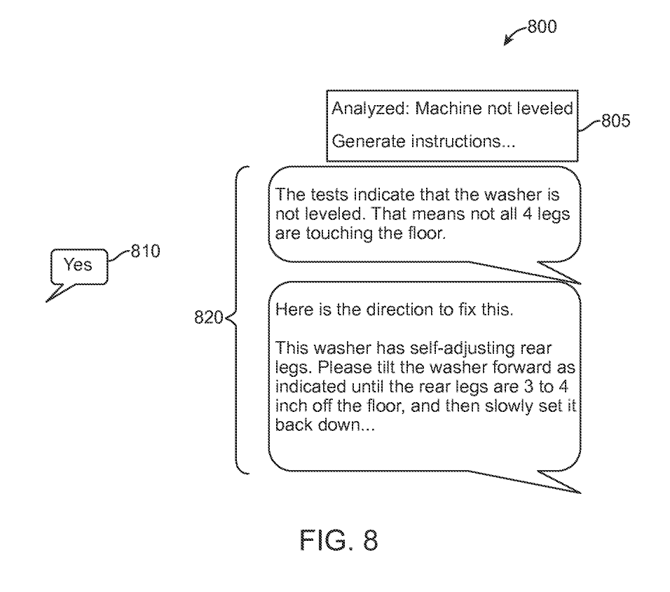

FIG. 8 shows an example dialog 800 for determining a solution and providing information for correction of a problem for an example interactive agent session, according to an embodiment. In one example, the dialog includes user dialog 810 and virtual agent dialog 820. Additionally, a result 805 of analysis by the communicating device and/or expert system is illustrated. Once a problem is identified, the communicating device communicates with the customer about the problems and proposes ways to resolve the problems. In many cases, the proposed resolution of the problem is discovered through the data gathered by mining customer support chat information. Depending on the problems verified, some problems may be resolved automatically (e.g., software configuration on a networked device or appliance), some problems may be resolved by a less skilled customer (e.g., changing the setting on an unconnected appliance), some problems may be resolved by a more skilled customer (e.g., leveling a washing machine), and other problems may only be resolved by a technician (e.g., replacing parts). In this portion of processing, the communicating device describes the problems to the customer, just like am actual technician would, and offers the customer a Do-It-Yourself (DIY) instruction or schedules an appointment with the actual technician.

In one example, the result diagnostic may be sent to the expert device, which may reside on the network. The result diagnostic information helps other customers to determine their problems, as some problems are more common on certain models of a device or appliance than the others. This diagnostic result information may also be summarized to report to the manufacturer of the device or appliance to provide feedback for improving products and services.

In one embodiment, sharing diagnostic information may be used for proactive triggering of the virtual support sessions. In one example, when a problem is found to be common on a particular device or appliance, the expert device, which may use continuous sensing to obtain context information about the customer's environment, notifies the customer through the communicating device, to proactively check whether there is the same problem on the customer's device or appliance. For example, the notification occurs before the customer is aware of any issue on the device or appliance.

In one embodiment, the virtual support agent is able to communicate with the customer to: create a list of possible problems (hypotheses); instruct the customer to perform simple actions; perform automated steps for gathering various signals from different sensors; analyze the signal for verifying or eliminating possible problems (hypotheses); propose fixes of the problems without any involvement from a support personnel, etc.

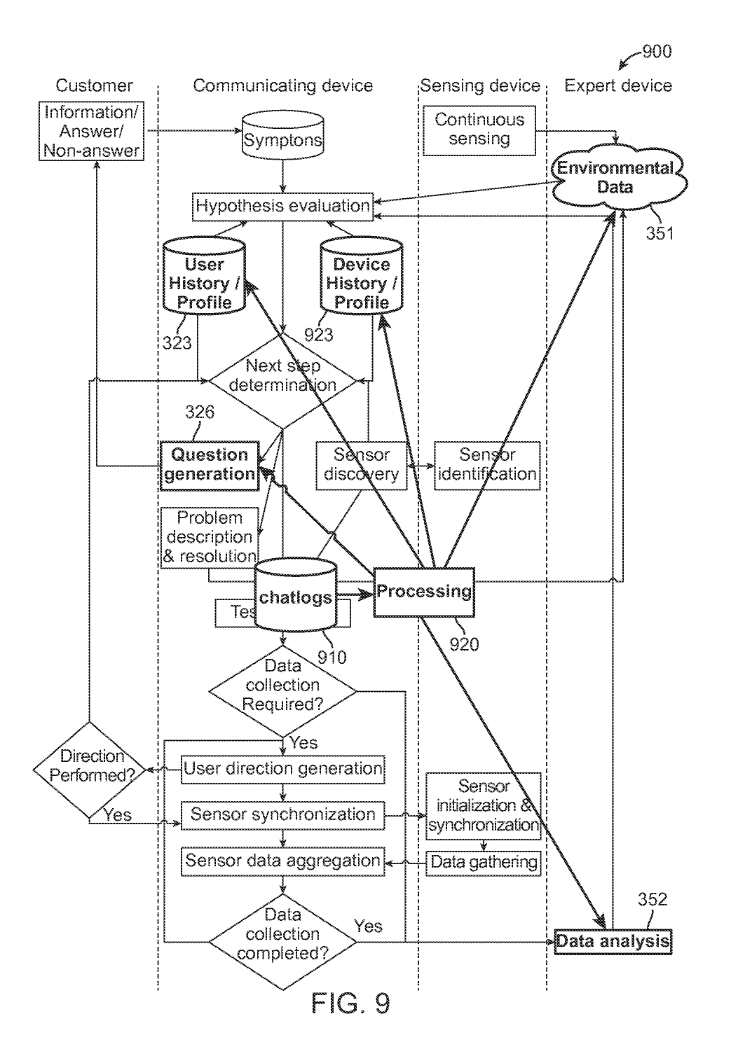

FIG. 9 shows an example 900 for integration of use of chat information into the interactive agent virtualization flow of FIG. 3, according to an embodiment. In one embodiment, the information that drives the virtual support is obtained from customer chat logs 920. In one example, the chat log information provides information that is used in various processing 920. In one example, the processing 920 may include, but is not limited to, the following:
1) User history/profile 323 understanding—it is challenging to learn the behavior/speech of one customer by himself/herself. In one embodiment, with customer chat logs 910, the interactive agent virtualization system learns from the customers in groups that behave similarly.
2) Device history/profile 324 understanding—sometimes device-specific problems are not well-understood right away. In one example, by using the customer chat logs 910, the information may be automatically obtained when it occurs.
3) Question generation—language evolves continuously. In one example, from the customer chat logs 910 the system may learn the appropriate way to communicate with customers.
4) Environmental data 351—customer chat logs 910 provide a large amount of related data to help building up the external environmental data 351.
5) Data analysis 352—customer chat logs 910 provides a large amount of useful information on how the symptoms and problems are correlated to each other.

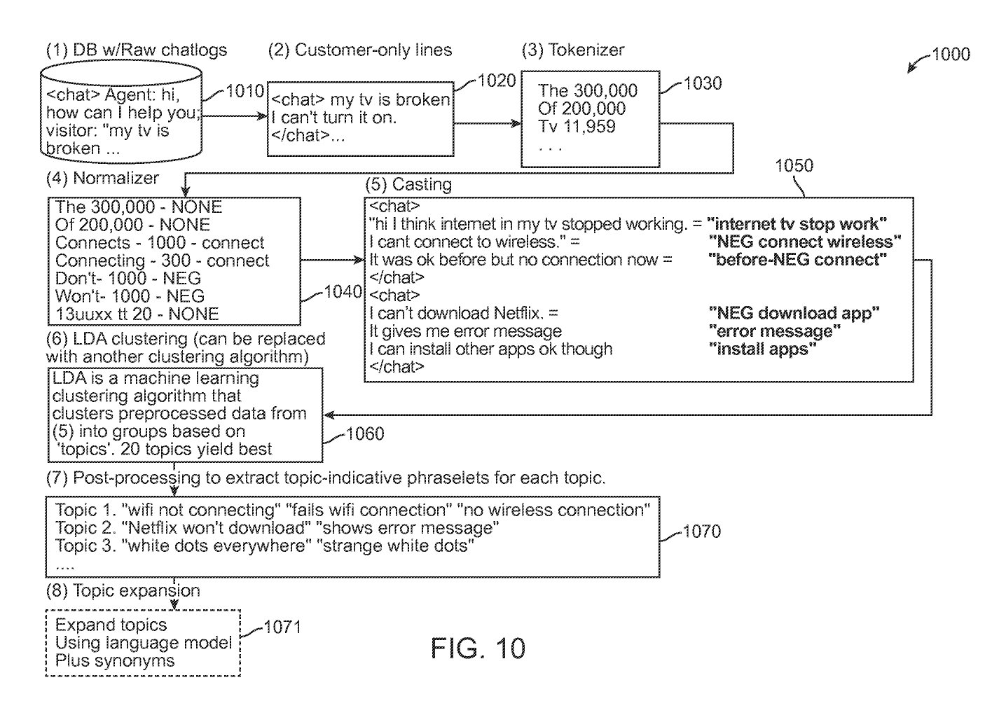

FIG. 10 shows a block diagram 1000 of extraction of core problems from customer/client collected information, according to an embodiment. Many companies offer customer support services via online chat that takes place between customers and customer support agents. A typical session may involve an agent greeting the customer, asking what problems he/she is experiencing, going through resolution steps, and hopefully resolving the problem. While basic methods that allow tracking the time of day of each customer-agent chat session, location of customer, type of product in question etc., there is no simple programmatic method to extract the specific issue the customer is having from the noisy, fragmented chat data, rife with misspellings, abbreviations, and irrelevant social dialogue between customers and agents (e.g., hellos, thanks yous, etc.). This information, however, may be critical for business needs. In one embodiment, the chat information (e.g., database of chat log information 1010) may inform business of the top common problems that are prevalent with a given product as indicated by the numerous complaints from customers; Note that the extraction is not mining behavior patterns or predicting attrition probability (churn) of any single given customer. In one example, the customer chat information is used with the goal of arriving at common core problems present in the data as a whole (i.e., not investigating problems of individual customers). In one embodiment, the extraction provides for building a better informed intelligent virtual agent that may be used for troubleshooting problems without invoking human-driven customer support.

In one example, the chat log information 1010 may provide for discovering new problems that arise that were not present before. For example, with the release of new firmware or updates to backend services may come previously unattested problems; other problems may arise as related to aging of a product device and its parts (e.g., mechanical parts), and also problems caused by changes in the environment (e.g., changes in TV broadcasting and cell phone wireless infrastructure).

In one example, the chat log information 1010 may provide information related to whether there is an association between a given model of a product and a type of issue. For example, a particular set of TV models may suffer from a display-related issue that other models do not have. There is no way to extract this intelligence just via searching for a model number because such a search will match numerous chat lines containing completely irrelevant information (e.g., phrases such as “the model of my TV is xywz,” “I have xyzw TV from Samsung,” etc. More specific information about a given model is needed to zero in on the problems that this model is prone to.

The extraction example 1000 process provides automated extraction of common issues that arise in customer complaints as well as automatic discovery of new or previously unseen issues present in the chat logs 1010 of interaction between customers and customer support agents. In one embodiment, the extracted problems may then be leveraged to form better hypothesis when an intelligent virtual agent that is attempting to troubleshoot customer's problem. In one example, the extraction process may also be used to determine the outcome of the conversation, e.g. whether the customer's issue was resolved or not. While there are surveys at the end of the chat session, many customers do not fill them out. In one embodiment, the extraction process mines this intelligence via analyzing the text of the chat sessions themselves to determine whether a solution to the problem was found. The data regarding resolution of customer issues may then be used to train new agents as well as gain insight into how to better assist customers.

In one embodiment, preprocessing is provided that sifts through millions of lines of raw noisy text, reducing dramatically the noise in the data, and allows a machine learning clustering process to cluster the data and discover prevalent topics (e.g., topics=problems customers experience). In one embodiment, text preprocessing includes elimination of irrelevant vocabulary to obtain meaningful results from a machine learning clustering process by reducing or eliminating a large number of irrelevant vocabulary. In one embodiment, the chat log information 1010 may be stored in a database or other structured memory element or device. In block 1020, the raw chat log information is processed to result in customer-only lines of text information. In one example, the customer-only lines are tokenized into words in block 1030 using a tokenizer module. The tokenized information is normalized in block 1040 using a normalizer module and then cast into phrases in block 1050 using a casting module. In one embodiment, the cast information is clustered into groups in block 1060 using a machine learning clustering process (e.g., Latent Dirichlet Allocation (LDA), etc.). In one embodiment, the clustered group information is then post-processed in block 1070 to extract topic indicative phraselets for each topic. In one embodiment, the topics may be expanded in block 1071 using language modeling and synonyms. Further details of the extraction processing are described below.

In one example, automatic discovery of core prevalent problems that customers experience with a given product (e.g., a TV, appliance, etc.) is provided by mining customer support chat logs that record online chat sessions between customers and customer support agents. In one embodiment, the process specifies the following operations:
1) take raw, noisy XML wrapped chat sessions that contain dialogues between customers and agents;
2) extract only the customer lines, eliminate noise (e.g. ‘hello’ ‘thank you’ and other small talk);
3) retain only the necessary vocabulary;
4) cast the customer part of the dialogue in the chat sessions only in terms of the retained key vocabulary;
5) feed the preprocessed customer sessions to a clustering process and extract, for example, 20-50 clusters, which represent the main topics present in customer complaints;
6) post-process the clustered chat sessions to extract human-readable phrases that would characterize the main topic of each cluster (e.g., ‘problem with wireless’, ‘fails to connect’ Wi-Fi not connecting′) from which a reader may infer that the topic concerns (e.g., a problem with a wireless connection).

In one example, the extraction processing focuses on chat sessions that concern various problems people are experiencing with their products (e.g., TVs), but the processing may be extended for assistance in technology issues, etc. In one example, the extraction processing automatically preprocess the raw data which in turn will enable the gathering of business intelligence regarding:

a) discovery of the top common problems that are prevalent with a given product;
b) discovery of new problems (not before seen), for example a new feature is released for a TV and introduces previously unattested problems. No simple “keyword-search-based” method would permit such a discovery as keywords one would need to look for do not exist for these new problems. Looking for “new” words does not allow distinguishing between relevant new words and some noisy new words;
c) discovery of whether there is an association between a given model of a product and type of issues.

In one embodiment, the data is pre-processed prior to feeding it to a clustering algorithm (e.g., LDA) in order to obtain meaningful results. In one example, once top core issues present in customer complaints are uncovered, the troubleshooting solution may be automated on a device itself, thus foregoing the need for customer support. In one embodiment, the virtual agent system comprises three main portions: 1) identifying current problems from customer complaints; 2) discovery of new problems that arise in recent chat logs; and 3) discovery of correlations between specific models and problems these models tend to have.

In one embodiment, in block 1010 the full dumps of, for example, XML wrapped chat session data files containing customer-agent interactions plus various XML markup information regarding date, time session ID and other meta-data are obtained. In one example, the files are downloaded from a website hosted by third party that provides customer support. In one example, customer service chat logs may have been collected over the past twelve months and are continually collected on a daily basis. An example of a single raw chat session between a customer and an agent is shown below:

<chat>
<Chat start_time=“2013-06-09T00:01:02+00:00”
end_time=“2013-06-09T00:09:58+00:00”>

| | |
|---|---|
| <line by=“info” | time=“2013-06- |

```
09T00:01:02+00:00”>
        <Text>Please  wait  for  a  Samsung  Agent  to
respond.</Text>
      </line>
        <Text>Your  Issue  ID  for  this  chat  is
LTK111790178569X</Text>
```

| | |
|---|---|
| <line by=“Nancy” | time=“2013-06- |

```
09T00:01:11+00:00” repId=“ID555”>
        <HTML>Hi,  thanks  for  reaching  out  to  Samsung
tech support. How can I help you today?>/HTML>
      </line>
```

| | |
|---|---|
| <line by=“Visitor” | time=“2013-06- |

```
09T00:01:13+00:00”>
        <Text>Hi </Text>
      </line>
```

| | |
|---|---|
| <line by=“Visitor” | time=“2013-06- |

```
09T00:01:30+00:00”>
        <Text>i  have  a  46″ 3d  smart  tv  7100
series</Text>
      </line>
```

| | |
|---|---|
| <line by=“Nancy” | time=“2013-06- |

```
09T00:03:06+00:00” repId=“ID555”>
        <Text>Hello! please  go  ahead  with  the
query.</Text>
      </line>
```

| | |
|---|---|
| <line by=“Visitor” | time=“2013-06- |

```
09T00:03:21+00:00”>
        <Text>My spdif output menu has 3 options - PCM,
Dolby digital  ,  DTS...  But  the  DTS  option  is  not
selectable... I have a receiver that is DTS compatible
attached via Optical cable</Text>
      </line>
```

| | |
|---|---|
| <line by=“Visitor” | time=“2013-06- |

```
09T00:03:38+00:00”>
        <Text>Please  help  me  select  the  DTS  option
</Text>
      </line>
```

| | |
|---|---|
| <line by=“Nancy” | time=“2013-06- |

```
09T00:04:50+00:00” repId=“ID555”>
        <Text>I  am  sorry  for  any  inconvenience.
</Text>
      </line>
</chat>.
```

In one example, in block 1020, from the raw XML files, only the lines that the customer said during a chat session are extracted. That is, only the customer's description of a problem is required in this portion, not the dialogues between customer and agent. In one example, customer-only lines are separated by chat session. In one example, individual chat session information is preserved by using “<chat> and </chat>” markers as identifiers of the beginning and end of each session. The above session would be reduced to the example customer lines below:

```
(2) <chat>
            <Text>Hi </Text>
            <Text>i  have  a  46″ 3d  smart  tv  7100
series</Text>
            <Text>My spdif output menu has 3 options - PCM,
Dolby digital  ,  DTS...  But  the  DTS  option  is  not
selectable... I have a receiver that is DTS compatible
attached via Optical cable</Text>
            <Text>Please  help  me  select  the  DTS  option
</Text>
    </chat>.
```

In one embodiment, in block 1020 the file containing customer only lines is tokenized—that is, broken into individual words. In one example, this is done in order to extract top-ranking words such that a given word is associated with its count. For example “tv 11,959” means that the word “tv” was mentioned 11,959 times in the total set of 3,400,000 lines of customer-only lines from TV related chat sessions.

In one embodiment, in block 1040 top ranking words, for example, those words having count 10 and up—that were extracted in block 1030 are examined. In one example, what counts as top-ranking may vary depending on the size of the collection and also on how fine-grained it is desired for the mining process to be. For example, if it is only cared about most dominant problems, the threshold of words that are cared about may be cut off at 50 or 100 count. In one example, important keywords, such as “Wi-Fi, wireless, connect, connection” are normalized to be reduced to the same form. For example, “connect, connects, connecting” are mapped to “connect;” “don't,” “not,” “isnt',” and “won't” are mapped to a basic term NEG to capture the fact that they encode negation. Several common positive adjectives such as “good,” “great,” and “perfect” are mapped to a common label “adj_positive”; several words related to buying are mapped to “buy” and tense information is removed. Several names of apps, for example ‘netflix,” “amazon” and “mlb,” specific vocabulary in Smart TV domain, were mapped onto the generic term “app,” In one embodiment, the normalization is processed in order to eliminate as much noise and variation in the data as possible, which in turn will promote better identification of clusters of issues. Known stop words (e.g., from industry standard stop word lists) are marked for removal automatically, for example words like “the” and “of” are mapped to the marker “NONE” which indicates that the word is to be removed. The stop words are usually the most top ranking words. Additionally, some words not normally thought of as stop words, are considered stop words in the context of customer support chat sessions and also marked for removal. For example, the word “model” is not normally considered a stop word, but for the purposes of customer support chat, it occurs too many times and carries little information. In one example, the word “model” is marked to be removed. In one example, any word that occurred below a threshold of count 10 is removed. This is done in order to focus only on the most common vocabulary that persists across chat logs. In one example, after pruning the stop words and the low ranking words, the remaining words include vocabulary of about 2500 words from the ‘middle tier’—not the most high count as are the stop words, but also occur more than 10 times.

In one embodiment, in block 1050, the entire data set of customer-only chat logs is then ‘cast’ in terms of only the pre-selected key words. In one embodiment, casting is a critical dimensionality reduction step that allows the extraction process to retain only the meaningful relevant vocabulary and to eliminate as much noise from the text as possible. For example, a phrase such as): “hi, i was wondering about this problem i have with my tv. It doesn't connect to the Wi-Fi even though i see my computer and other devices connected to Wi-Fi. i don't understand why that is” is cast in terms of only the key words and is shown in table 1:

TABLE 1

| PREPROCESSED ‘CAST’ LINE | ORIGINAL LINE. |
|---|---|
| problem tv | hi, i was wondering about |
| | this problem i have with my |
| | tv. |
| NEG connect Wi-Fi | It doesn't connect to the Wi- |
| | Fi even though |
| Computer device connect Wi-Fi | i see my computer and other |
| | devices connected to Wi-Fi |
| NEG understand | i don't understand why that |
| | is |

In one example, in block 1060 each preprocessed chat session is written into its own individual file, as this is the format required for the clustering software LDA. Each session is treated as its own ‘document’ and the clustering is to arrive at the topic(s) that compose this document. For example, in the dialog in table 1, the main topic is ‘Wi-Fi connection issue’. For the purposes of clustering, from the preprocessed chat session, only the top three lines are taken. This is because the statement of the problem, which is what we are interested in, happens in the first few lines of the session. After that, the agent and the customer engage into the troubleshooting of the problem, which creates various divergent threads of conversation, and hence is not useful for identifying core top-ranking problems. Each of the preprocessed lines is linked via an index to its original so that processing may ‘reverse normalize’ the data and recover the original from which the preprocessed form was derived. This is shown in below:

```
problem tv
  NEG connect Wi-Fi
  Computer device connected Wi-Fi
```

In one example, as a result of preprocessing, ˜247,000 individual customer-only chat session files remain, each of which resembles a snippet. Some chat sessions that were present in the original chat logs are reduced to 0 because they either contained words that were too low ranking or contained mostly stop words, or were very short (e.g., only one word). Since the goal is to identify the most high-ranking issues that are prevalent in agent-customer interactions, dropping sessions with low ranking words is acceptable.

In one example embodiment, in block 1060 the preprocessed collection of ˜247K short chat sessions is given as input to a topic—modeling third party package for LDA clustering (e.g., MALLET). MALLET uses LDA to cluster documents into N topics, where N is defined by the user. Experiments conducted with N topics=20, 30, and 50. In one example, N=20 topics appears the most easy-to-understand, stable results. LDA assigns each document, where document is one preprocessed chat session, to several topics. However, most of the time, there is a dominant topic in each session; one that represents what the session is mostly about. It should be noted that any other clustering algorithm may be used for the purpose of identifying main clusters/topics in the collection of individual preprocessed chat sessions containing first three customer-only chat lines. Further, experiments in which raw un-preprocessed data was given to the LDA were conducted and yielded no identifiable topics. Preprocessing in terms of casting data in terms of top-ranking content-relevant key words is thus crucial to obtaining good persistent topics. The discovered topics were subsequently replicated with various data sets, big, small, intermediate as well as brand new data sets. For example, problems with wireless connection are a topic that can be found in small set of chat logs, large set of chat logs, and brand new chat logs (e.g., as of recent weeks).

In one embodiment, in block 1070 the documents clustered by LDA are then subjected to a final post-processing step that extracts phraselets from the clustered sessions that were most characteristic of the dominant topic of the cluster. This is needed because LDA assigns topics to documents that are numbered and then provides some key words such as “wireless, connect, Wi-Fi, internet” to identify each numeric topic. However, the keywords LDA provides as identifiers for each numeric topic are hard to understand. In one example, extraction of characteristic phraselets for each numeric topic is performed to aid human-readability of the topic. For example, suppose that we have documents 1, 2, and 3 grouped into topic 19 by LDA such that topic 19 is the dominant topic in these 3 documents. To find out what exactly this topic 19 is about, we extracted high occurrence tri-grams from the top ranking documents (also known as chat sessions) grouped into topic 19 by LDA. Crucially, topic-indicative phraselets are extracted from the chat sessions that were not preprocessed to aid readability. For example, each of the preprocessed chat sessions is linked to its original, as shown in Table 1. In one example, key indicative phrases are extracted from the original customer line, not from the preprocessed one. The ‘reverse normalization’ is important for human consumption in the same way as normalization is required for machine consumption. The result is that topic 19 is now indexed with phraselets such as “problem connect Wi-Fi” “Wi-Fi connect failed.” From these names it can be inferred that this topic is about Wi-Fi connection.

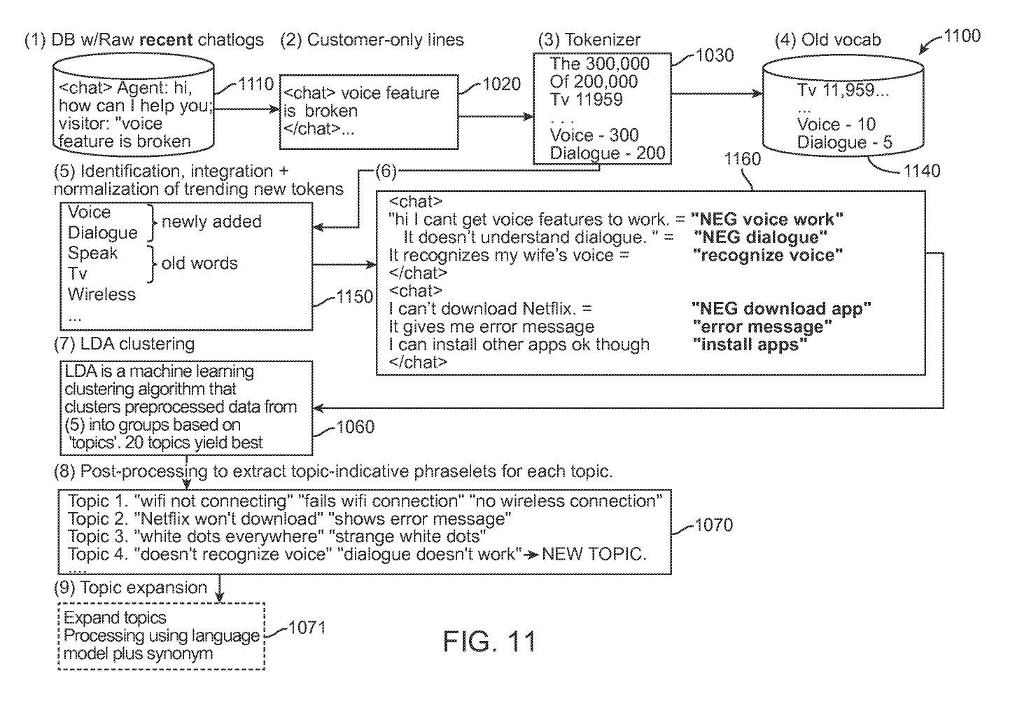

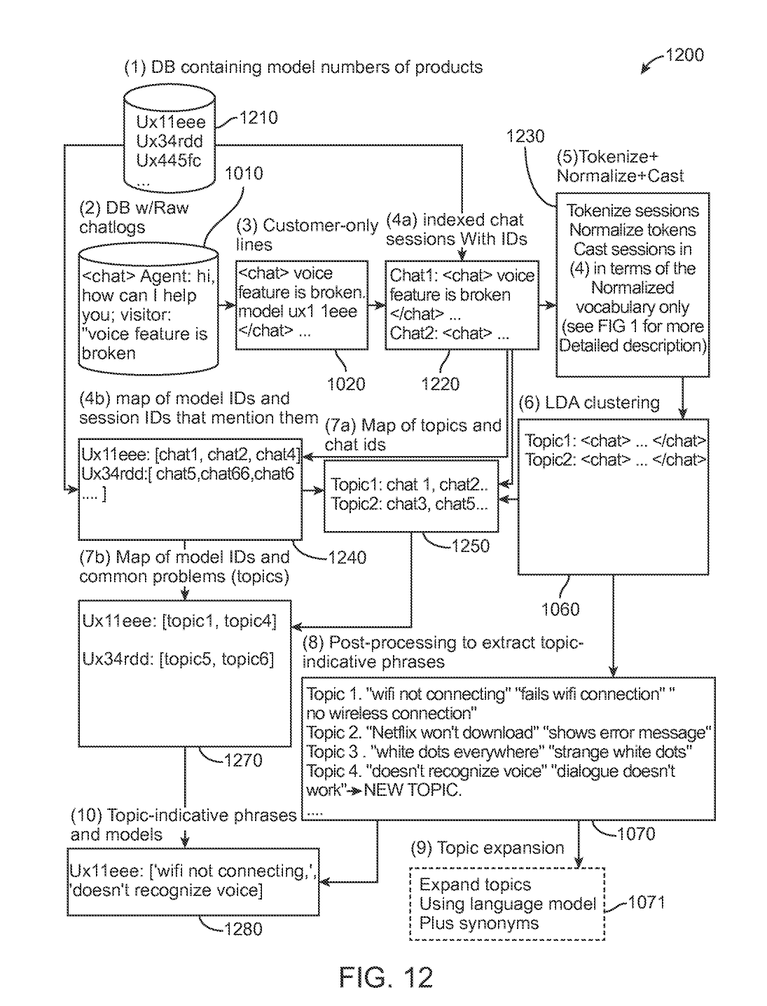

FIG. 11 shows a block diagram 1100 of discovery of new topics in customer/client collected information, according to an embodiment. Once core vocabulary is extracted based on a large set of previously collected chat logs, the vocabulary may be leveraged to find new topics that were previously unattested in the chat logs. In one embodiment, high ranking vocabulary in new incoming chat logs that do not occur in the current vocabulary yet does not match known stop words or occurs below a set threshold in the current vocabulary is analyzed. For example, suppose prior to a particular date, the occurrence of the words “voice” and “dialogue” was very low (e.g., less than ten). Hence, these words did not make it into the vocabulary set and any chat sessions containing complaints about “dialogue not working” would be represented only as “NEG work”: the information regarding “dialogue” would be lost. Now suppose that in the more recent chat logs, after the particular date, the count of these words has increased to greater than ten, which is not surprising given the introduction of voice features on a new smart TV. The word ‘dialogue’ clearly should be incorporated into the vocabulary to aid discovery of new problems in the incoming customer chat sessions.

In one embodiment, a periodic (e.g., once a month) vocabulary checker is executed that tokenizes new sets of chat sessions (collected over the course of the past month) and collects any tokens such that they have a count greater than ten, but are missing from the existing token list. New words may be examined to determine that there are no “false positives”—irrelevant tokens that have high counts for some reason. However, this examination is not strictly necessary: most high ranking words are rarely accidentally present. To ensure accurate count comparisons, newly collected vocabulary counts are compared to the vocabulary extracted from several once a month periods earlier on (otherwise, a count of a given token may be very low, but only due to the fact that the data set corresponds to one month of chat information and not one year of chat information). Newly discovered high ranking words may then be added into the vocabulary.

In one embodiment, the recent chat log information 1110 may be stored in a database or other structured memory element or device. In block 1020, the recent raw chat log information is processed to result in customer-only lines of text information. In one example, the customer-only lines are tokenized into words in block 1030 using a tokenizer module. The tokenized information is normalized in block 1140 using a normalizer module. In block 1150 integration of identification and normalization of trending new tokens is conducted, and then cast into phrases in block 1160 using a casting module. In one embodiment, the cast information is clustered into groups in block 1060 using a machine learning clustering process (e.g., LDA, etc.). In one embodiment, the clustered group information is then post-processed in block 1070 to extract topic indicative phraselets for each topic. In one embodiment, the topics may be expanded in block 1071 using language modeling and synonyms. Further details of the discovery of new topics in chat logs processing are described below.

In on embodiment, in block 1140 the list of word tokens from block 1030 are compared to a vocabulary set collected previously over a same duration of time (e.g., one month). In one example, the comparison in block 1140 looks for:
i. Brand new word tokens that have a count greater than, for example ten, that are present in newly collected chat session information but completely absent from previously collected vocabulary. The threshold may vary but can be computed as a factor of overall word frequency distribution. For example, for very large sets of chat logs, it may be greater than ten occurrences per word. It should be noted that the count of ten is given only as a working example.
ii. Word tokens that had a count less than ten in previously collected vocabulary but now have a count greater than ten.

In one embodiment, in block 1150 trending new words are identified and normalized. Trending new words may be defined as those whose occurrence suddenly spiked (e.g., doubled, tripled, etc.). The actual threshold may be established after several trials. For example, if ‘voice’ occurred only nine times during the month of May 2012, but occurred thirty times during the month of July 2013, then it can be stated that use of this word has spiked and is ‘trending’ relative to its former usage. It may not be ‘trending’ relative to some other high count tokens that have always had high occurrence rates, for example “TV” or “wireless.” Extraction of new high ranking words and addition of these words are placed into an existing database of vocabulary.

In block 1160, with newly discovered high ranking words (e.g., those count ten and higher) cast all the subsequent chat logs in terms of the augmented vocabulary.

In block 1060 the clustering processing is re-run on the newly cast data, and then post-processing occurs in block 1070. New vocabulary discovery may lead to identification of previously unattested topics, which may illustrate new problems that have recently arisen. Even without rerunning the clustering processing in block 1060, but merely looking at the newly discovered high ranking words may yield interesting insights into the new patterns in customer-agent interaction, such as giving some glimpse as to the issues customers are experiencing.

FIG. 12 is a block diagram 1200 of discovery correlations between product model numbers and dominant problems, according to an embodiment. In one example, the processing may ‘pivot’ the preprocessed and clustered data from chat logs to determine whether there are particular product models are more prone to certain problems than others. In one embodiment, in block 1210 a list of all known product model numbers are obtained and stored (e.g., in a database, etc.). In block 1010 the raw chat logs containing chat sessions between customers and customer support agents are obtained. In block 1020, all but customer-only lines are removed from the chat log information.

In block 1220 each chat session delimited by, for example, <chat></chat> and containing customer-only lines are indexed with an ID. In one example, the ID is represented as a simple ID “Chat1”: <chat> line2, line2, . . . </chat>, “chat2”. In block 1240 every chat ID obtained in is stepped through, e.g., reading the corresponding chat session; and step through model numbers obtained in block 1210. In one embodiment, if a match is found, a map is created such that the model number is the key and the list of chat IDs of chat sessions that mention this model number is the value. For example, in (1) below, a mention of a model number that matches one in the known model number list. Once matched, the chat ID of this session (e.g., ‘chat1’) is placed into a list of values for this model number. IDs of other chat sessions that mention the same model number are placed into the list of values for this model number (as shown in (2) below).

```
(1)  <line by=“Visitor” time=“2013-06-08T00:01:13+00:00”>
      <Text>UN46F5500AFXZA</Text>
    </line>
    <line  by=“Shane  S” time=“2013-06-08T00:01:40+00:00”
repId=“ID563”>
      <Text>Thank  you  for  providing  the  model
number.</Text>
      </line>
(2)  { UN46F5500AFXZA: [chat1, .. chat10]}.
```

In block 1230 tokenization, normalization, and casting are performed. In block 1060 clustering is performed. In block 1070 post-processing of the chat logs collected in block 1020 is performed. In one embodiment, in block 1250 from the LDA clustered sessions, chat IDs of the clustered sessions are extracted. This may be performed by leveraging the map of IDs and sessions created in block 1220. For example, “Topic1: chat1, chat 233, chat2” “Topic 2: chat 2, chat2233, chat3”. While each session may have more than one topic, the processing concerns the most dominant topic of each session.

In block 1270, a map is created such that a model ID is the key and the value is a list of topics that group together chat sessions mentioning this model ID. In one example, the map of model IDs and chat IDs are leveraged from block 1240 and a map of topics and chat IDs are created in block 1250. For example, the result may be {MODEL_ID1:Topic1, Topic2, MODEL_ID2: Topic3, Topic4 . . . }. For example, it may be that model ID xyz is mentioned in chat sessions with IDs chat2, chat3, chat4 that are grouped in the topic1 and topic 2, which respectively correspond to problems with Wi-Fi connection and apps installing. This allows to “pivot” the clustered sessions by model ID and arrive at groups of problems that are characteristic of a given model ID.

In block 1280, topic indicative phrases extracted in the post-processing of block 1070 may be leveraged to determine what specific topics each model suffers from the most. In one embodiment, the topics may be expanded in block 1071 using language modeling and synonyms.

One or more embodiments employ data preprocessing that allows to gather vital business intelligence concerning the kinds of problems customers are having currently, discover novel problems that arise with the introduction of new features into products, and finally ‘pivot’ problems based on product model number that may be characteristic of a given model. In one example, data preprocessing is crucial in order to arrive at meaningful clusters of dominant problems and gain critical business information.

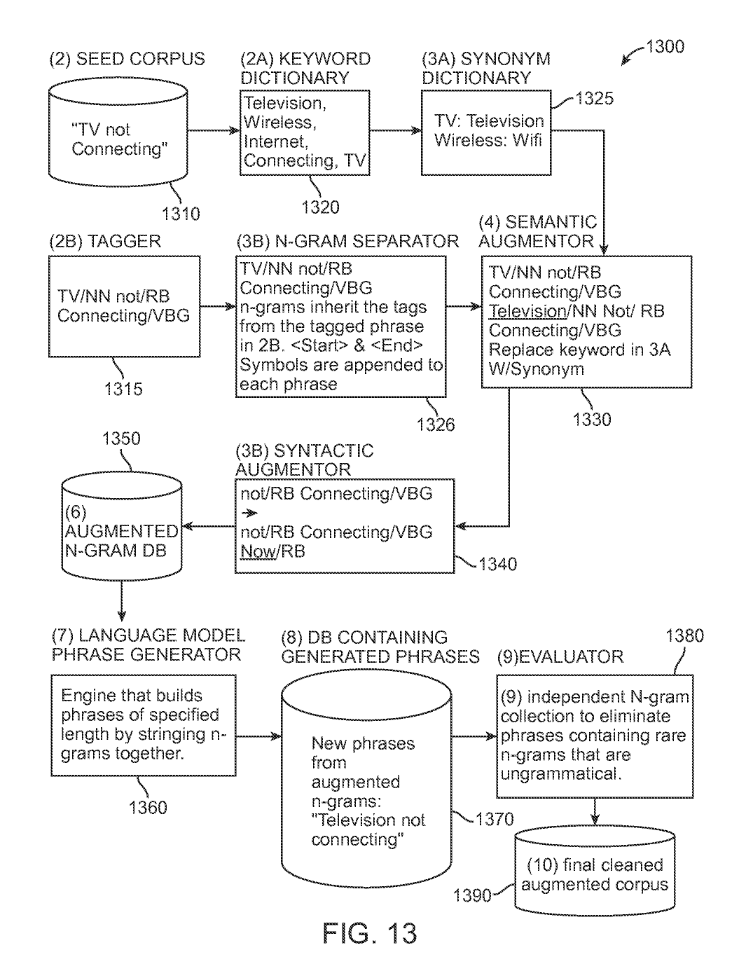

FIG. 13 shows a flow diagram 1300 for expanding the topic-indicative phraselets using language modeling and synonyms, according to an embodiment. In one embodiment, in block 1310 a seed corpus of phrases is obtained to bootstrap phrase generation from, for example, a third party or manually built corpus, etc. In one example, a corpus of 1000-5000+ topic-specific phrases on some semantically cohesive topic (example: some standard product problems/issues, e.g., “my TV is blank,” “there is no sound from my receiver,” “my washing machine fails to drain,” etc.) is developed.

In block 1320 the key words that are semantically indicative of the topic are specified (e.g., “display,” “sound,” “picture” may be key words for the topic “Problems.” In block 1325, synonyms or more generally semantically related words (hyponyms, meronyms) to each of the specified topic key words are obtained (e.g., dots, spots, distortions, etc. The semantically related words may be obtained from a host of sources, for example: starting from manual enumeration and including online resources such as WordNet, any other external thesaurus, etc. In one embodiment, block 1325 is one of several key steps that differ from conventional system that only use statistical language modeling techniques. In one embodiment, using the synonym dictionary is used together with statistical language modeling. In one example, the flow diagram 1300 utilizes language modeling and insertion of synonyms to the keywords into n-grams for phrase generating purposes. N-grams are adjacent sequences of words of size n (n being a positive integer). For example, a sentence “wireless not connecting” is represented as two bigrams (n-grams of size two) “wireless not” and “not connecting.”

In block 1315 the corpus is tagged with part-of-speech (POS) tags via a POS tagger. In one example, block 1315 may be performed in parallel with blocks 1320 and 1325. In block 1326 n-grams from each phrase in the input corpus are created. In one example, n-grams generally include bigrams and trigrams. The n-grams may also carry their associated POS-tags. In one example, “start” and “end” symbols are appended to the beginning and end of each phrase, respectively, prior to separating it into n-grams in block 1326. For example, a phrase such as “TV/NN not/RB connecting/VBG” is represented as “<start> TV/NN not/RB connecting/VBG <end>.” This is done in order to know which n-grams are licit to begin or end a phrase, thus maximizing the naturalness and grammaticality of results during phrase generation in block 1360. For example, some n-grams cannot normally start a sentence and should not be placed in the beginning. After a phrase is separated into n-grams on block 1326, the n-grams carry the POS tags present in the original corpus and the ‘start’/‘end’ symbols, as shown in the example below:
“<start> TV/NN” “TV/NN not/RB” “not/RB connecting/VBG” “connecting/VBG <end>”

In block 1330, semantic augments are added. In one embodiment, for each n-gram that contains a word specified as a key word, the word in the n-gram is replaced with its synonym obtained in block 1325 (e.g., for a bigram such as “TV not,” an augmented bigram “Television/NN not/RB” is obtained by replacing “TV” with “television.” In one example, the semantic augmentor in block 1330 depicts leveraging a dictionary of synonyms to increase the number of possible n-grams from which sentences may be built. This is distinguishable from conventional systems that rely solely on using what is in the corpus and building out more phrases only from the ones used in the corpus. In contrast, one or more embodiments introduce into a statistical language model a linguistic, “rule-based-like” technique of specifying synonyms for a given lexical word. This allows for increasing the number of possible n-grams and for those n-grams that are not present in the corpus to be used for generating more diverse set of sentences.

In block 1340, syntactic augments are added. In one example, for each semantically augmented n-gram generated in block 1330, a syntactic augment is added from a limited set of possible augments, such as intensifier adverbs that may be placed next to verbs or adjectives, etc. In one example, the augment is added based on the parts of speech present in the n-gram. For example, from the bigram, “not/RB connecting/VBG” an augmented bigram “not/RB connecting/VBG now/RB” may be obtained by augmenting the original bigram “not/RB connecting/VBG” with the adverbial augment “now”. In one example, the placement of the adverbial augment is specified in advance based on the general syntactic properties of the language. In English, it is before or after the main verb. In one embodiment, several hand-crafted rules for placement of syntactic augments are created independently and utilized during construction of augmented n-grams. In one example, the number of these rules is very limited. Augmented n-grams are placed into an augmented n-gram database in block 1350. The insertion of syntactic augments in addition to the usage of synonyms is used to increase the number of possible n-grams.

In block 1360, from the augmented set of n-grams obtained in block 1340 and 1350, every possible sentence up to a particular (e.g., selected) length is generated by joining together permissible sequences of n-grams. In one example, standard language modeling techniques may be used in generating phrases from augmented n-grams. In one example, n-grams with <start> and <end> symbols must be used as starting and ending n-grams respectively in all generated phrases to avoid building non-sense phrases. Two bigrams may be concatenated together if and only if the last word of the preceding bigram is the same as the first word of the following bigram (e.g., “TV not” and “not connecting” can combine together because they overlap by “not”. It should be noted that combining trigrams together requires that the last two words of the preceding trigram equal the first two words of the following trigram (e.g., “TV not connecting” can combine with “not connecting anymore” to form “TV not connecting anymore” but not with “connecting problems” because overlapping in only one word results in an odd phrase “TV not connecting problems”). In one example, better phrases are built by combining trigrams together to generate new phrases, not bigrams. For ease of explanation, this description provides examples using bigram generation only.

In one example, the length of the final generated phrase should be around the same as the average phrase length in the input corpus to be maximally faithful to the input. For example, a set of augmented bigrams in the augmented n-gram (e.g., bigrams) database 1350 may contain bigrams such as “<start> TV” “TV not” “not connecting” “connecting to” “connecting now” “television not” and “now <end>”, “connecting <end>.” The bigrams may be joined together into phrases such as “TV not connecting” “Television not connecting” “Television not connecting now” “TV not connecting now”, etc. As a result, a new corpus is obtained that contains previously unseen phrases (e.g. “television not connecting now”) that resemble the style of the initial corpus, but contain more semantic and grammatical variation due to the linguistics augments (e.g., synonyms and adverbials). Standard language modeling techniques do not involve placing linguistic augments and are thus limited to having only the vocabulary present in the initial seed corpus. One or more embodiments provide for “inserting” new words into existing bigrams via synonymy as well as via adding syntactic augments where grammatically appropriate. In one embodiment, the generated new phrases are placed into a database 1370.

In one example, in block 1380 odd phrases are eliminated by running the generated set against a third party collection of n-grams. If n-grams contained in a generated phrase have very low incidence in a large collection of n-grams, the phrase is likely ill-formed and needs to be eliminated. In one embodiment, the final cleaned corpus of generated phrases are placed into database 1390.

One or more embodiments expand the seed corpus on a phrase-basis, for example by adding similar phrases to the ones found in the seed corpus, not entire documents. In one example, the augmented phrases are added to the seed corpus by virtue of being generated from a linguistically augmented language model, not by being harvested from the web or from some other external source. Crucially, there is no requirement to have any external source or online connection at all for corpus expansion. The only collection that is required is the seed corpus.

One or more embodiments implement a semantically and syntactically ‘aware’ language model that leverages a compiled seed corpus of a few thousand lines containing sample phrases on a given topic (for example related to a customer service agent for product problems/issues; etc.) together with a thesaurus of synonyms, a list of simple syntactic augments (e.g., adverbials such as “now, really, anymore,”) and a POS tagger to automatically generate more utterances similar in style and content to the seed corpus. Synonyms and syntactic augments provides for building augmented n-grams from the initial seed phrase. Augmented n-grams such as “not connecting ‘now/anymore’ and “television not” are automatically created from the original n-grams by leveraging synonyms like “television ˜TV” and placing grammatical augments “now/anymore” where appropriate. The augmented n-grams are then combined together to generate new phrases, not found in the seed corpus, following standard language modeling techniques.

The ‘hybrid’ language model is in this sense linguistically ‘aware’ and is able to generate many more varied utterances than what is found in the original seed corpus, while adhering to the original structure and topic of the seed corpus. The language model is ‘hybrid’ because it combines a statistical language modeling technique for generating new phrases via n-grams with a linguistic technique of using synonyms and syntactic augments to build new phrases, as in rule-based approaches. In one embodiment, the combination of different language generation (statistical language modeling and insertion of linguistic augments into the n-grams) provides for avoiding hand-crafting specific rules, by leveraging a language model as the main phrase-generating engine, while still utilizing linguistic insights (e.g., expanding possible new phrases via synonymy and grammatical augments). As a result, from the initial phrase “TV not connecting” one or more embodiments may automatically build new phrases such as “Television not connecting anymore” “TV not connecting now” etc. by stringing together augmented n-grams that are similar in content and style to the seed corpus. Those generated phrases that are for some reason semantically/syntactically odd may then be ruled out by leveraging an independent n-gram corpus (e.g., Google® n-gram corpus) to detect phrases containing n-grams with very low incidence rates. Such phrases will then be removed from the generated collection.

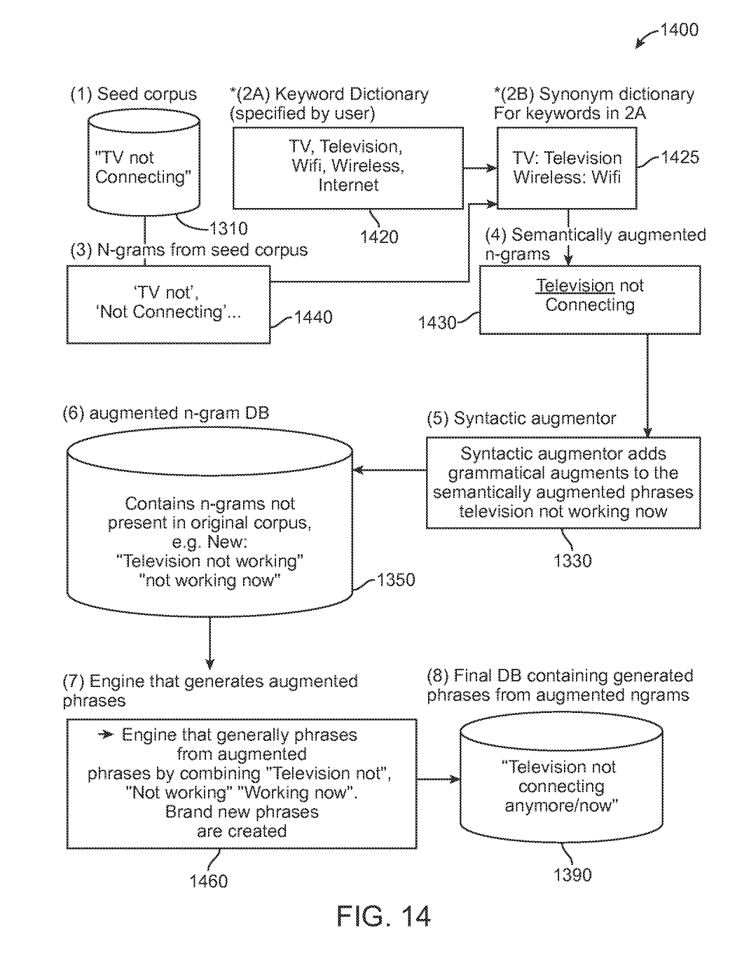

FIG. 14 shows another flow diagram 1400 for expanding the topic-indicative phraselets using language modeling and synonyms, according to an embodiment. The flow diagram 1400 is a higher level flow diagram then flow diagram 1300 (FIG. 13) and focuses on aspects of one or more embodiments that critically distinguish it from conventional systems by implementing a synonym dictionary to pre-specified keywords, insertion of these synonyms into n-grams from existing corpus, and insertion of syntactic augments into the n-grams. Flow diagram 1400 includes the seed corpus 1310, user-specified keyword dictionary 1420, synonym dictionary 1425 for the keywords from 1420, n-grams from the seed corpus 1440, semantically augmented n-gram processing 1430, syntactic augmentor processing 1330, the augmented n-gram database 1350, the engine 1460 that generates the augmented phrases and the final database 1390 containing generated phrases from the augmented n-grams.

In one embodiment, new phrases are generated from a seed corpus by creating manual context-free rules that allow for generation of more phrases given the annotated lexicon from the seed corpus. In one example, the hand-crafted rules and word annotation are time consuming and require a trained linguist(s) to create and fine tune them. Additionally, to expand another seed corpus, new rules have to be created, as they are tailored to the syntactic style and the specific meaning of the seed corpus in order to avoid generating nonsense phrases. In contrast, the one or more embodiments require only a clean seed corpus, a specification as to which words are key words and are to be expanded via synonyms, and a small list of syntactic augments together with a short list of rules dictating their placement.

A trained linguist is not required to make a determination regarding key words for a seed corpus. For example, if the seed corpus concerns a topic of food, mere common sense is sufficient to indicate that words such as “TV” “Wireless” “internet” are topic-central key words. It is therefore a more expert-independent solution to the problem of corpus expansion. Unlike purely linguistic systems that rely on hand-crafted rules and annotated vocabulary for language generation, the current proposal leverages the n-gram model as the main generative ‘engine’ and hence does not require a trained linguist to supervise the process, provide rules and annotations, which saves significant cost.

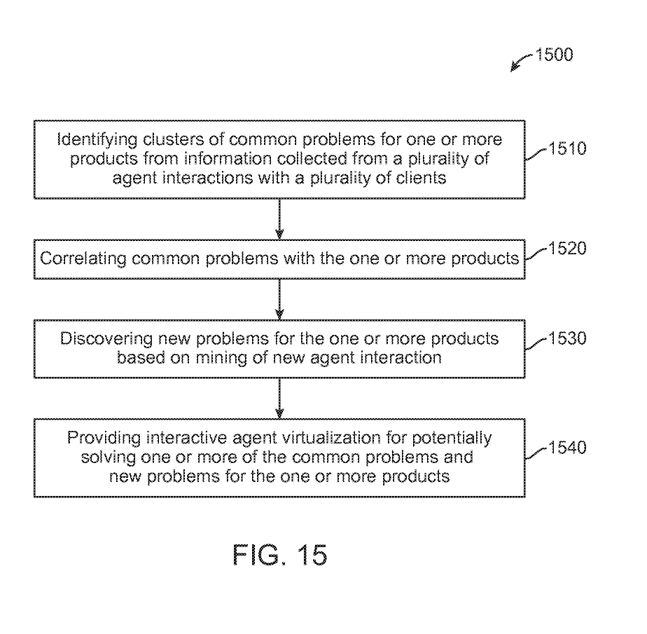

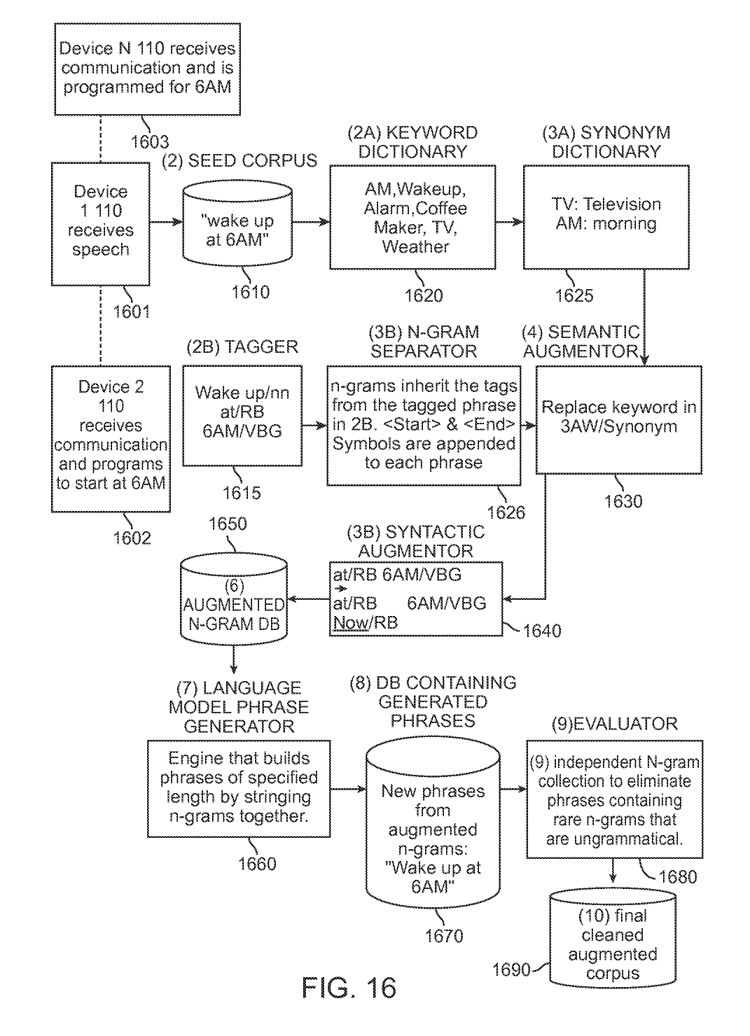

FIG. 15 shows a flow diagram 1500 for interactive agent virtualization for product problem solving, according to an embodiment. In one embodiment, in block 1510 clusters of common problems for one or more products are identified from information collected from a many agent interactions with a multiple clients or users. In block 1520, common problems are correlated with one or more products. In block 1520, new problems for the one or more products are discovered based on mining of the agent interactions. In block 1540 interactive agent virtualization is provided for potentially solving one or more of the common problems and new problems for the one or more products.

In one example, mining the agent interactions may include analyzing and collecting text information from client dialogue portions of the agent interactions. One embodiment may include tokenizing the text information, normalizing text information from tokenized text information, casting text information using normalized text information, and clustering casted text information based on one or more topics (e.g., problems with products, product models, etc.).

One embodiment of process 1500 may include processing clustered casted text information for extracting topic-indicative phraselets for each of the one or more topics. In one example, the topic-indicative phraselets may be expanded in process 1500 by using language modeling and synonyms (e.g., flow diagram 1300, FIG. 13, flow diagram 1400, FIG. 14).

One embodiment may include identifying trending new tokenized text from one or more chat logs in process 1500. In one example, particular product models and session identifications indicative of the particular product models are mapped. The one or more topics are mapped with the session identifications. The particular product models are mapped with the one or more topics.

In one example, process 1500 may include expanding the topic-indicative phraselets may include selecting a keyword dictionary, selecting a synonym dictionary based on the selected keyword dictionary, semantically augmenting n-grams based on the selected synonym dictionary, adding grammatical augments to semantically augmented n-grams, and generating augmented phrases based on grammatically and semantically augmented n-grams.

In one example, interactive agent virtualization of process 1500 includes using one or more electronic device sensors for communicating sensor information for assistance in solving one of the one or more common problems and one or more new problems for one or more products. In one example, the electronic device sensors may include any of: vibration sensor information, temperature sensor information, sound information, humidity information, magnetic field information, proximity information, light information, rotational information, movement information, etc.

In one embodiment, the interactive agent virtualization of process 1500 includes technician emulation based on interactive communication with a user and the one or more electronic device sensors. In one example, the interactive agent virtualization includes communication between one or more electronic devices and a server or cloud-based service.

In one example, in process 1500 the one or more electronic devices may include any of: a television device, a smart phone device, a tablet device, a wearable device, etc.

One embodiment relates to a unified Smart Home natural language-based interface/control platform. In one example, a system of multiple product devices 110 (FIG. 1) provides a user interface/user experience (UI/UX) that links individual device-specific commands to unify control of multiple product devices 110 by learning user contexts. The following describes an example use case, which may be considered as an extension of the context-aware diagnostic embodiments described above.

One embodiment involves communicating speech (e.g., speaking, uttering, using synthetic voice, using a recorded voice, etc.) to a product device 110, for example, “I have to wake up and go to work.” The speech would be recognized as a voice command. Since there are many variations of saying the command “I have to wake up and go to work,” such as “I must wake up and go,” “I have to wake up at 7 AM,” etc., one embodiment first involves a collection of a large seed corpus of user commands, and then expands the corpus of these commands via a linguistically aware language model. In one example, this is accomplished in a manner similar to expanding possible user utterances related to diagnosing problems with product devices 110 as described above.

FIG. 16 shows a flow diagram for expanding the topic-indicative phraselets for a Smart Home system including multiple product devices 110 using language modeling and synonyms, according to an embodiment. In one embodiment, a process for operating a unified Smart Home natural language-based interface/control platform may involve collecting a large corpus of voice commands (1610), performing voice-to-text transcription (1620-1625), applying POS-tagging (1615) to the resulting text commands, segmenting the commands into n-grams (1626, 1630, 1640 and 1650), and building a linguistically aware language model that is used to generate new commands (1660, 1670, 1680 and 1690).

For example, the phrase “I must wake up at 6 AM” may be used as an input command, obtained by device 1 110 at 1601, in the seed corpus 1610. The input command is then tagged with POS tags at 1615, and a synonym dictionary 1625 is used to map possible wake up times or periods, such as 6 AM: 7 AM, 8 AM, 9 AM-10 AM, etc.; “must: have to, should,” etc. In one example, syntactic augments are then used at 1630, and the augmented n-grams are fed into the n-gram DB 1650 (after syntactically augmented at 1640) from which language model phrase generator is built at 1660, and the phrases are stored at 1670, evaluated at 1680 and cleaned up at 1690. Novel commands can be generated in the manner analogous to what is described for FIGS. 13 1360 (7) and 1370 (8).

In one embodiment, similar expanded corpus may be applied to other user commands such as “turn on coffee maker” and “turn on news on channel 5.” Expanded corpus of commands for multiple connected smart home devices (e.g., device 2 110 at 1602 to device N 110 at 1603) is built similarly in a manner shown in, and described in reference to FIG. 13.

In one embodiment, by communicating (e.g., speaking, using a recorded voice, etc.) to a product device 110, for example, “I have to wake up and go to work,”—a command or a linguistic variation of this command that is understood via having an expanded linguistically aware language model that contains a large corpus of possible utterances—the product device 110 learns and associates the physical context of that command to the existing commands that were previously given to other connected product devices 110.

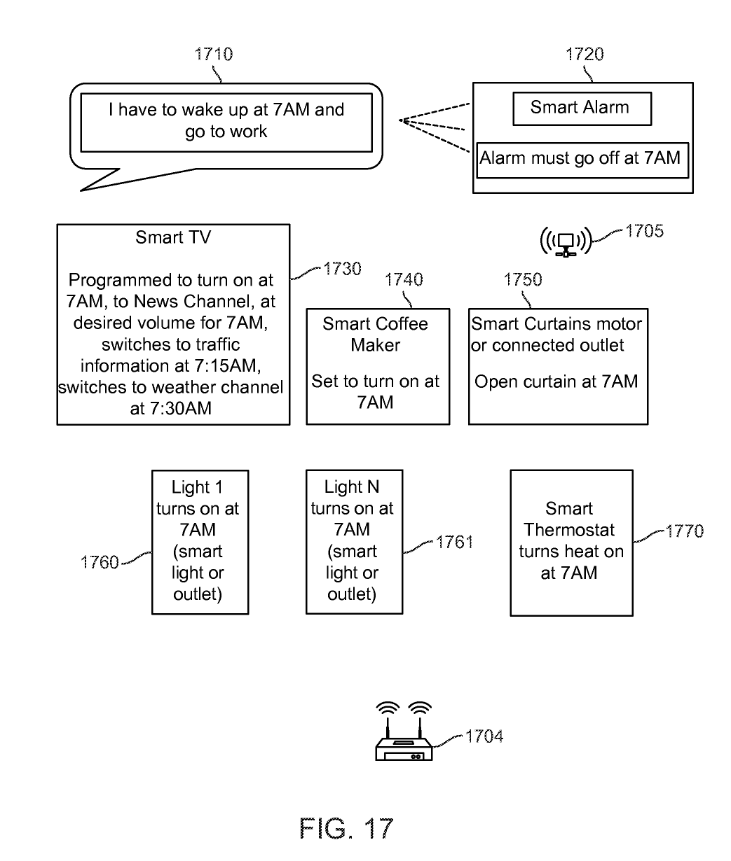

FIG. 17 shows an example interaction by smart home devices in a network that use language modeling and synonyms, according to an embodiment. In one example, a connected network is formed using a wireless device (e.g., a wireless router 1704) that connects the product devices 110 wirelessly by a wireless protocol 1705 (e.g., BLUETOOTH®, Wi-Fi, NFC, 3G, 4G, etc.). In one example, the connected network includes product devices 110, such as a smart alarm 1720, a smart TV 1730, a smart coffee maker 1740, a smart curtains motor or connected outlet 1750, a smart light 1 or outlet 1 1760 to a smart light N or outlet N 1761, and a smart thermostat 1770.

In one example, every time a user issues a command to a smart alarm 1720, for example by saying “I have to wake up at 7 AM and go to work” at 1710, the other connected product devices 110 in the connected network learn that command in this context; a user also then may expect to have the following additional actions performed by other connected product devices based on the context: turn on the lights 1 to N 1760 to 1761, open the curtains by the windows (e.g., by smart switches connected to or by smart curtain motorized devices 1750), turn on the TV (e.g., a smart TV 1730) to display the morning news on a specific channel or turn on a radio/stereo/satellite radio, etc. device to a desired station, display traffic information at a specified time (e.g., on a smart device, smart TV, etc.), display or inform of current/future weather at a specified time, turn on the smart coffee maker 1740 to make coffee, turn up a thermostat 1770 to a higher temperature, etc.

In one embodiment, other product devices 110 are controlled contextually through a user issuing a single command to a single device. Other product devices 110 perform their tasks automatically, without having to be programmed explicitly or having explicit linguistic commands issued to them. In one example, it is enough that a) a command is issued to one of the connected product devices 110 and b) that the connected product devices 110 are aware of each other contextually and ‘know’ that if a command is issued, for example, to set a smart alarm for 7 AM, then other smart devices, such as the coffee maker 1740, smart TV 1730, and smart thermostat 1770, must also be turned on as usual at that same time.

In another example, if a user (or user proxy, such as a recording) issues a command to a product device 110, such as a smart TV 1730, the night before and utters “turn on channel 6 news at 7 AM tomorrow,” the other product devices 110, such as a smart alarm 1720, a smart thermostat 1770, a smart fireplace (on and off times set), smart garage door (open/close at specific times), a connected vehicle (e.g., start the car to warm up at a particular time), etc. are set automatically to perform their respective tasks at that time. Other use cases may involve other times of day, specific calendar days, special events, etc. with other types of smart devices or connected devices.

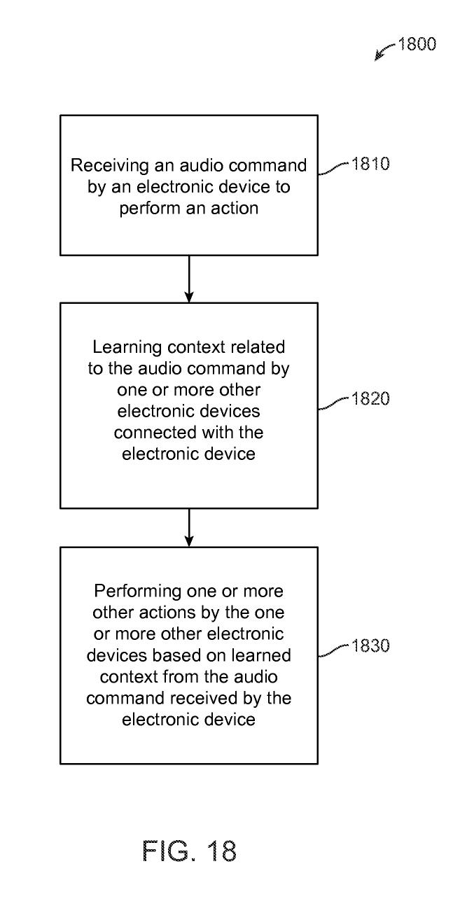

FIG. 18 shows a flow diagram 1800 for a Smart Home with connected devices using contextual learning for performing multiple product device actions, according to an embodiment. In one embodiment, in block 1810 an audio command (e.g., audio speech) is received by an electronic device (e.g., a product device 110, FIG. 1) to perform an action. In block 1820, context related to the audio command is learned by one or more other electronic devices connected with the electronic device. In block 1830, one or more other actions are performed by the one or more other electronic devices based on learned context from the audio command received by the electronic device.

In one embodiment, process 1800 may further include processing text information obtained from the audio command for extracting phraselets based on the context. Process 1800 may also include expanding the phraselets using language modeling and synonyms (e.g., as flow diagram 1300, FIG. 13, flow diagram 1400, FIG. 14, flow diagram, FIG. 16).

In one example, expanding the phraselets may include selecting a keyword dictionary, selecting a synonym dictionary based on the selected keyword dictionary, semantically augmenting n-grams based on the selected synonym dictionary, adding grammatical augments to semantically augmented n-grams, and generating augmented phrases based on grammatically and semantically augmented n-grams.

In one example, process 1800 includes learning context by using one or more electronic device sensors for obtaining sensor information for assisting in determining context. In one example, sensor information may include one or more of: vibration sensor information, temperature sensor information, sound information, humidity information, magnetic field information, proximity information, light information, rotational information, movement information, etc.

In one embodiment, the other electronic devices use historical information (e.g., when certain electronic devices are used, the context that those electronic devices are used, actions for those electronic devices, ordered actions, times, dates, etc.) for learning user behavior for action programming based on the learned context. In one example, the one or more other electronic devices are controlled contextually based on the audio command received by the electronic device. In one example, for process 1800 the action and the one or more other actions are related based on the learned context.

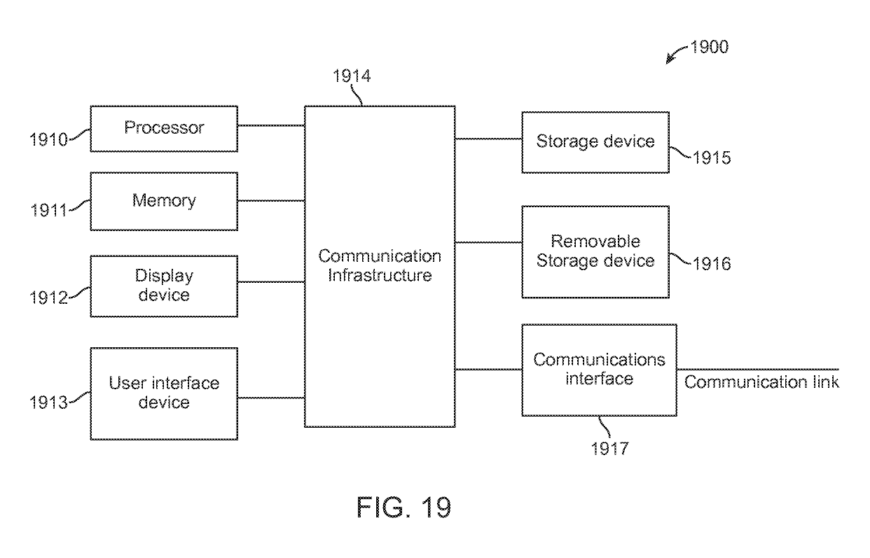

FIG. 19 is a high level block diagram showing a computing system 1900 comprising a computer system useful for implementing an embodiment. The computer system 1900 includes one or more processors 1910, and can further include an electronic display device 1912 (for displaying graphics, text, and other data), a main memory 1911 (e.g., random access memory (RAM)), storage device 1915, removable storage device 1916 (e.g., removable storage drive, removable memory module, a magnetic tape drive, optical disk drive, computer readable medium having stored therein computer software and/or data), user interface device 1913 (e.g., keyboard, touch screen, keypad, pointing device), and a communication interface 1917 (e.g., modem, a network interface (such as an Ethernet card), a communications port, or a PCMCIA slot and card). The communication interface 1917 allows software and data to be transferred between the computer system 1900 and external devices. The system further includes a communications infrastructure 1914 (e.g., a communications bus, cross-over bar, or network) to which the aforementioned devices/modules are connected as shown.

Information transferred via communications interface 1917 may be in the form of signals such as electronic, electromagnetic, optical, or other signals capable of being received by communications interface, via a communication link that carries signals and may be implemented using wire or cable, fiber optics, a phone line, a cellular phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

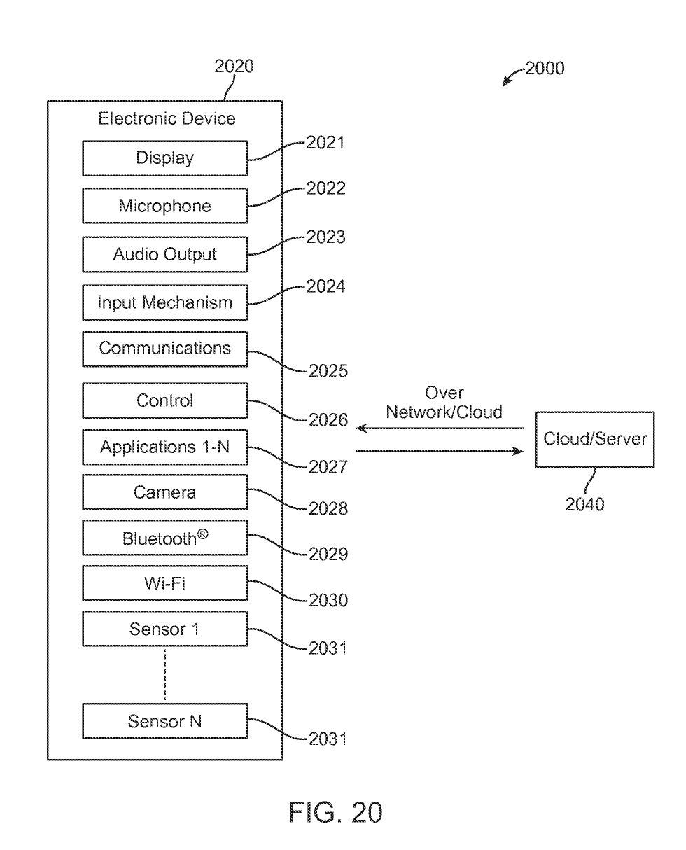

FIG. 20 shows a functional block diagram of an architecture system 2000 that may be used for resource and activity monitoring using an electronic device 2020. Both a communicating device 201 (FIG. 2), sensing devices 120-124 (FIG. 1) may include some or all of the features of the electronics device 2020. In one embodiment, the electronic device 2020 may comprise a display 2021, a microphone 2022, an audio output 2023, an input mechanism 2024, communications circuitry 2025, control circuitry 2026, Applications 1-N 2027, a camera module 2028, a BLUETOOTH® module 2029, a Wi-Fi module 2030 and sensors 1 to N 2031 (N being a positive integer) and any other suitable components. In one embodiment, applications 1-N 2027 are provided and may be obtained from a cloud or server 2040, a communications network, etc., where N is a positive integer equal to or greater than 1.

In one embodiment, all of the applications employed by the audio output 2023, the display 2021, input mechanism 2024, communications circuitry 2025, and the microphone 2022 may be interconnected and managed by control circuitry 2026. In one example, a handheld music player capable of transmitting music to other tuning devices may be incorporated into the electronics device 2020.

In one embodiment, the audio output 2023 may include any suitable audio component for providing audio to the user of electronics device 2020. For example, audio output 2023 may include one or more speakers (e.g., mono or stereo speakers) built into the electronics device 2020. In some embodiments, the audio output 2023 may include an audio component that is remotely coupled to the electronics device 2020. For example, the audio output 2023 may include a headset, headphones, or earbuds that may be coupled to communications device with a wire (e.g., coupled to electronics device 2020 with a jack) or wirelessly (e.g., BLUETOOTH® headphones or a BLUETOOTH® headset).

In one embodiment, the display 2021 may include any suitable screen or projection system for providing a display visible to the user. For example, display 2021 may include a screen (e.g., an LCD screen, a curved screen, etc.) that is incorporated in the electronics device 2020. As another example, display 2021 may include a movable display or a projecting system for providing a display of content on a surface remote from electronics device 2020 (e.g., a video projector). Display 2021 may be operative to display content (e.g., information regarding communications operations or information regarding available media selections) under the direction of control circuitry 2026.

In one embodiment, input mechanism 2024 may be any suitable mechanism or user interface for providing user inputs or instructions to electronics device 2020. Input mechanism 2024 may take a variety of forms, such as a button, keypad, dial, a click wheel, or a touch screen. The input mechanism 2024 may include a multi-touch screen.

In one embodiment, communications circuitry 2025 may be any suitable communications circuitry operative to connect to a communications network (e.g., a communications network) and to transmit communications operations and media from the electronics device 2020 to other devices within the communications network. Communications circuitry 2025 may be operative to interface with the communications network using any suitable communications protocol such as, for example, Wi-Fi (e.g., an IEEE 802.11 protocol), BLUETOOTH®, high frequency systems (e.g., 900 MHz, 2.4 GHz, and 5.6 GHz communication systems), infrared, GSM, GSM plus EDGE, CDMA, quadband, and other cellular protocols (3G, 4G, etc.), VOIP, TCP-IP, or any other suitable protocol.

In some embodiments, communications circuitry 2025 may be operative to create a communications network using any suitable communications protocol. For example, communications circuitry 2025 may create a short-range communications network using a short-range communications protocol to connect to other communications devices. For example, communications circuitry 2025 may be operative to create a local communications network using the BLUETOOTH® protocol to couple the electronics device 2020 with a BLUETOOTH® headset.

In one embodiment, control circuitry 2026 may be operative to control the operations and performance of the electronics device 2020. Control circuitry 2026 may include, for example, a processor, a bus (e.g., for sending instructions to the other components of the electronics device 2020), memory, storage, or any other suitable component for controlling the operations of the electronics device 2020. In some embodiments, a processor may drive the display and process inputs received from the user interface. The memory and storage may include, for example, cache, Flash memory, ROM, and/or RAM/DRAM. In some embodiments, memory may be specifically dedicated to storing firmware (e.g., for device applications such as an operating system, user interface functions, and processor functions). In some embodiments, memory may be operative to store information related to other devices with which the electronics device 120 performs communications operations (e.g., saving contact information related to communications operations or storing information related to different media types and media items selected by the user).

In one embodiment, the control circuitry 2026 may be operative to perform the operations of one or more applications implemented on the electronics device 2020. Any suitable number or type of applications may be implemented. Although the following discussion will enumerate different applications, it will be understood that some or all of the applications may be combined into one or more applications. For example, the electronics device 2020 may include a resource usage, resource information processing (e.g., appliance usage, fixture usage, etc.) and user activity application, location application (e.g., mobile electronic device location determination application), an automatic speech recognition (ASR) application, a dialog application, a map application, a media application (e.g., QuickTime, MobileMusic.app, or MobileVideo.app), social networking applications (e.g., FACEBOOK®, TWITTER®, etc.), an Internet browsing application, etc. In some embodiments, the electronics device 2020 may include one or multiple applications operative to perform communications operations. For example, the electronics device 2020 may include a messaging application, a mail application, a voicemail application, an instant messaging application (e.g., for chatting), a videoconferencing application, a fax application, or any other suitable application for performing any suitable communications operation.

In some embodiments, the electronics device 2020 may include one or more microphones 2022. For example, electronics device 2020 may include microphone 2022 to allow the user to transmit audio (e.g., voice audio) for speech control and navigation of applications 1-N 2027, during a communications operation or as a means of establishing a communications operation or as an alternative to using a physical user interface. The microphone 2022 may be incorporated in the electronics device 2020, or may be remotely coupled to the electronics device 2020. For example, the microphone 2022 may be incorporated in wired headphones, the microphone 2022 may be incorporated in a wireless headset, the microphone 2022 may be incorporated in a remote control device, etc.

In one embodiment, the camera module 2028 comprises one or more camera devices that include functionality for capturing still and video images, editing functionality, communication interoperability for sending, sharing, etc., photos/videos, etc.

In one embodiment, the Bluetooth® module 2029 comprises processes and/or programs for processing BLUETOOTH® information, and may include a receiver, transmitter, transceiver, etc.

In one embodiment, the electronics device 2020 may include multiple sensors 1 to N 2031, such as accelerometer, gyroscope, microphone, temperature, light, barometer, magnetometer, compass, radio frequency (RF) identification sensor, etc.

In one embodiment, the electronics device 2020 may include any other component suitable for performing a communications operation. For example, the electronics device 2020 may include a power supply, ports, or interfaces for coupling to a host device, a secondary input mechanism (e.g., an ON/OFF switch), or any other suitable component.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

Embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of one or more embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method comprising:
receiving an audio command by an electronic device to perform an action;
learning context related to the audio command by one or more other electronic devices connected with the electronic device; and
performing one or more other actions by the one or more other electronic devices based on learned context from the audio command received by the electronic device.

2. The method of claim 1, further comprising:
processing text information obtained from the audio command for extracting phraselets based on the context.

3. The method of claim 2, further comprising:
expanding the phraselets using language modeling and synonyms.

4. The method of claim 3, wherein the expanding comprises:
selecting a keyword dictionary;
selecting a synonym dictionary based on the selected keyword dictionary;
semantically augmenting a plurality of n-grams based on the selected synonym dictionary;
adding grammatical augments to semantically augmented n-grams; and
generating augmented phrases based on grammatically and semantically augmented n-grams.

5. The method of claim 1, wherein learning context comprises using one or more electronic device sensors for obtaining sensor information for assisting in determining context.

6. The method of claim 5, wherein the one or more electronic device sensors comprise one or more of: vibration sensor information, temperature sensor information, sound information, humidity information, magnetic field information, proximity information, light information, rotational information, and movement information.

7. The method of claim 1, wherein the other electronic devices use historical information for learning user behavior for action programming based on the learned context.

8. The method of claim 7, wherein the one or more other electronic devices are controlled contextually based on the audio command received by the electronic device.

9. The method of claim 1, wherein the action and the one or more other actions are related based on the learned context.

10. The method of claim 1, wherein the electronic device or the one or more other electronic devices comprise smart product devices.

11. The method of claim 10, wherein the smart product devices comprise an alarm device, a television device, a smart coffee maker, smart electrical outlet controllers, lighting devices, a smart phone device, a tablet device, or a wearable device.

12. An apparatus comprising:
an electronic product device connected with one or more other electronic product devices, the electronic product device is configured to receive an audio command, to interpret the audio command, to perform an action, and to communicate with the one or more other electronic product devices for learning context related to the audio command by the one or more other electronic product devices, wherein the one or more other electronic product devices are configured to perform one or more other actions based on learned context from the audio command received by the electronic product device.

13. The apparatus of claim 12, wherein the electronic product device is further configured to process text information obtained from the audio command for extracting phraselets based on the context.

14. The apparatus of claim 13, wherein the electronic product device is further configured to expand the phraselets using language modeling and synonyms.

15. The apparatus of claim 14, wherein the electronic product device is further configured to expand the phraselets by selecting a keyword dictionary, selecting a synonym dictionary based on the selected keyword dictionary, semantically augmenting a plurality of n-grams based on the selected synonym dictionary, adding grammatical augments to semantically augmented n-grams, and generating augmented phrases based on grammatically and semantically augmented n-grams.

16. The apparatus of claim 12, wherein the one or more other electronic product devices learn context based on using one or more electronic product device sensors for obtaining sensor information used for determining context.

17. The apparatus of claim 16, wherein the sensor information comprises one or more of: vibration sensor information, temperature sensor information, sound information, humidity information, magnetic field information, proximity information, light information, rotational information, and movement information.

18. The apparatus of claim 12, wherein the one or more other electronic product devices use historical information for learning user behavior for action programming based on the learned context and the audio command.

19. The apparatus of claim 12, wherein the one or more other electronic product devices are controlled contextually based on the audio command received by the electronic product device.

20. The apparatus of claim 12, wherein the action and the one or more other actions are related based on the learned context.

21. The apparatus of claim 12, wherein the electronic product device or the one or more other electronic devices comprise smart product devices.

22. The apparatus of claim 21, wherein the smart product devices comprise an alarm device, a television device, a smart coffee maker, smart electrical outlet controllers, lighting devices, a smart phone device, a tablet device, or a wearable device.

23. An apparatus comprising:
an electronic device coupled with a processor, wherein the electronic device:
provides interactive agent virtualization for potentially solving one or more of common problems and new problems for one or more products using information that is collected from a plurality of agent interactions with a plurality of clients.

24. The apparatus of claim 23, wherein the electronic device communicates with a server device that:
identifies clusters of common problems for the one or more products;
correlates common problems with the one or more products;
discovers the new problems for the one or more products based on mining of the information; and
mines the agent interactions by analyzing and collecting text information from client portions of the agent interactions.

25. The apparatus of claim 24, wherein the server further:
tokenizes the text information;
normalizes text information from tokenized text information;
casts text information using normalized text information;
clusters casted text information based on one or more topics; and
processes clustered casted text information and extracts topic-indicative phraselets for each of the one or more topics.

26. The apparatus of claim 25, wherein the server is configured for expanding the topic-indicative phraselets using language modeling and synonyms, and identifying trending new tokenized text from one or more chat logs stored in the memory.

27. The apparatus of claim 23, wherein said interactive agent virtualization comprises using one or more electronic device sensors for communicating sensor information for assistance in solving one of the one or more common problems and one or more new problems for the one or more products.

28. The apparatus of claim 27, wherein the sensor information comprises one or more of: vibration sensor information, temperature sensor information, sound information, humidity information, magnetic field information, proximity information, light information, rotational information, and movement information.

29. The apparatus of claim 23, wherein the interactive agent virtualization comprises technician emulation based on interactive communication with a user and the one or more electronic device sensors, and communication between one or more other electronic devices and the server or a cloud-based service.

30. The apparatus of claim 23, wherein the electronic device and the one or more other electronic devices comprise one or more of a television device, a smart phone device, a tablet device, and a wearable device.
